(19) United States
(12) Patent Application Publication
(10) Pub. No.: US 2026/0100808 A1
(43) Pub. Date: Apr. 9, 2026

(54) CONFIGURATION AND DETERMINATION OF RESOURCE BLOCK OFFSETS FOR UPLINK TRANSMISSION ACROSS SUB-BAND FULL DUPLEX (SBFD) AND NON-SBFD SYMBOLS

(71) Applicant: QUALCOMM Incorporated, San Diego, CA (US)

(72) Inventors: Muhammad Sayed Khairy ABDELGHAFFAR, San Jose, CA (US); Abdelrahman Mohamed IBRAHIM, San Diego, CA (US)

(21) Appl. No.: 19/330,421

(22) Filed: Sep. 16, 2025

Related U.S. Application Data
(60) Provisional application No. 63/703,082, filed on Oct. 3, 2024.

(51) Int. Cl. H04L 5/14; H04L 5/00; H04W 72/20

(52) U.S. Cl. CPC H04L 5/14; H04L 5/0044; H04W 72/20

(57) ABSTRACT

Methods, systems, and devices for wireless communications are described. Generally, the described techniques may enable a user equipment (UE) to determine and apply one or more resource block (RB) offsets to a frequency-domain resource allocation in a non-sub-band full duplex (non-SBFD) symbol to determine the starting RB of a transmission occasion in an uplink sub-band of an SBFD symbol. In some examples, the UE may receive semi-static configuration signaling of the one or more RB offsets. In another example, the UE may receive semi-static configuration signaling of two or more RB offsets and an indication of which RB offset to apply to determine the starting RB. Additionally, or alternatively, the UE may determine the starting RB based on implicit indication of the RB offset.

### CROSS REFERENCES

The present Application for Patent claims benefit of U.S. Provisional Patent Application No. 63/703,082 by ABDELGHAFFAR et al., entitled “CONFIGURATION AND DETERMINATION OF RESOURCE BLOCK OFFSETS FOR UPLINK TRANSMISSION ACROSS SUB-BAND FULL DUPLEX (SBFD) AND NON-SBFD SYMBOLS,” filed Oct. 3, 2024, assigned to the assignee hereof, and expressly incorporated herein.

### FIELD OF TECHNOLOGY

The following relates to wireless communications, including configuration and determination of resource block offset for uplink transmission across sub-band full duplex (SBFD) and non-SBFD symbols.

### BACKGROUND

Wireless communications systems are widely deployed to provide various types of communication content such as voice, video, packet data, messaging, broadcast, and so on. These systems may be capable of supporting communication with multiple users by sharing the available system resources (such as time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, UEs may receive configurations for uplink transmissions and downlink receptions across sub-band full duplex (SBFD) and non-SBFD symbols in different slots.

### SUMMARY

The systems, methods, and devices of this disclosure each have several innovative aspects, no single one of which is solely responsible for the desirable attributes disclosed herein.

One innovative aspect of the subject matter described in this closure can be implemented in a method for wireless communication by a user equipment (UE). The method includes receiving an indication of scheduling information for a set of multiple uplink transmissions via one or more sub-band full duplex (SBFD) symbols and one or more non-SBFD symbols and a resource block (RB) offset associated with a frequency-domain resource allocation (FDRA) of the scheduling information, where the RB offset indicates a location of a starting RB of one or more uplink transmissions of the set of multiple uplink transmissions within one or more RBs of an uplink sub-band during the one or more SBFD symbols and transmitting, via the uplink sub-band, the set of multiple uplink transmissions in accordance with the scheduling information and the RB offset.

Another innovative aspect of the subject matter described in this disclosure can be implemented in a UE. The UE includes one or more memories storing processor executable code, and one or more processors coupled with the one or more memories. The one or more processors may individually or collectively be operable to execute the code to cause the UE to receive an indication of scheduling information for a set of multiple uplink transmissions via one or more SBFD symbols and one or more non-SBFD symbols and an RB offset associated with a FDRA of the scheduling information, where the RB offset indicates a location of a starting RB of one or more uplink transmissions of the set of multiple uplink transmissions within one or more RBs of an uplink sub-band during the one or more SBFD symbols and transmit, via the uplink sub-band, the set of multiple uplink transmissions in accordance with the scheduling information and the RB offset.

Another innovative aspect of the subject matter described in this disclosure can be implemented in a UE. The UE may include means for receiving an indication of scheduling information for a set of multiple uplink transmissions via one or more SBFD symbols and one or more non-SBFD symbols and an RB offset associated with a FDRA of the scheduling information, where the RB offset indicates a location of a starting RB of one or more uplink transmissions of the set of multiple uplink transmissions within one or more RBs of an uplink sub-band during the one or more SBFD symbols and means for transmitting, via the uplink sub-band, the set of multiple uplink transmissions in accordance with the scheduling information and the RB offset.

Another innovative aspect of the subject matter described in this disclosure can be implemented in a non-transitory computer-readable medium storing code. The code may include instructions executable by one or more processors to receive an indication of scheduling information for a set of multiple uplink transmissions via one or more SBFD symbols and one or more non-SBFD symbols and an RB offset associated with a FDRA of the scheduling information, where the RB offset indicates a location of a starting RB of one or more uplink transmissions of the set of multiple uplink transmissions within one or more RBs of an uplink sub-band during the one or more SBFD symbols and transmit, via the uplink sub-band, the set of multiple uplink transmissions in accordance with the scheduling information and the RB offset.

In some examples of the method, UEs, and non-transitory computer-readable medium described herein, receiving the indication of the scheduling information may include operations, features, means, or instructions for receiving, in accordance with the set of multiple uplink transmissions being associated with type 1 physical uplink shared channel (PUSCH) transmissions with a configured grant, a radio resource control (RRC) message that includes a configured grant configuration, where the configured grant configuration includes a configured uplink grant information element, and where the configured uplink grant information element includes an RRC parameter that indicates the RB offset. In some examples of the method, UEs, and non-transitory computer-readable medium described herein, receiving the indication of the scheduling information may include operations, features, means, or instructions for receiving, in accordance with the set of multiple uplink transmissions being associated with type 2 PUSCH transmissions with a configured grant, or in accordance with the set of multiple uplink transmissions being scheduled by one or more dynamic grant physical downlink shared channel (PDSCH) transmissions, an RRC message that includes a PUSCH configuration, where the PUSCH configuration includes a set of multiple RB offsets including the RB offset.

In some examples of the method, UEs, and non-transitory computer-readable medium described herein, the location of the starting RB of the one or more uplink transmissions may be at least in accordance with a first value modulo a quantity of physical RBs (PRBs) of the uplink sub-band and the first value includes the RB offset added to a starting RB of an uplink bandwidth part. In some examples of the method, UEs, and non-transitory computer-readable medium described herein, the location of the starting RB of the one or more uplink transmissions may be with reference to a first RB of the uplink sub-band. In some examples of the method, UEs, and non-transitory computer-readable medium described herein, the location of the starting RB of the one or more uplink transmissions may be in accordance with a starting RB of the uplink sub-band, the RB offset, the starting RB of an uplink bandwidth part, and a quantity of PRBs of the uplink sub-band.

In some examples of the method, UEs, and non-transitory computer-readable medium described herein, the location of the starting RB of the one or more uplink transmissions may be at least in accordance with a first value modulo a quantity of PRBs of the uplink sub-band, the first value including the RB offset added to a starting RB of an uplink bandwidth part and the location of the starting RB of the one or more uplink transmissions may be with reference to a first RB of the uplink sub-band that may be a starting PRB of a resource block group (RBG) grid.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that include a user equipment (UE) and a network entity that support configuration and determination of resource block (RB) offset for uplink transmission across sub-band full duplex (SBFD) and non-SBFD symbols.

FIGS. 3A through 3E show examples of explicit RB offset configurations that support a UE in determining an RB offset for uplink transmission across SBFD and non-SBFD symbols.

FIGS. 4A and 4B show examples of implicit RB offset configurations that support a UE in determining an RB offset for uplink transmission across SBFD and non-SBFD symbols.

FIGS. 5A and 5B show examples of RB offsets for resource block group (RBG) grids that support a UE in determining an RB offset for uplink transmission across SBFD and non-SBFD symbols.

FIGS. 6A and 6B show examples of RB offsets for contiguous and non-contiguous physical resource block (PRB) allocations that support a UE in determining an RB offset for uplink transmission across SBFD and non-SBFD symbols.

FIG. 7 shows an example of a process flow that supports configuration and determination of RB offsets between a UE and a network entity for uplink transmission across SBFD and non-SBFD symbols.

FIGS. 8 and 9 show block diagrams of devices that include a UE and support configuration and determination of an RB offset for uplink transmission across SBFD and non-SBFD symbols using the RB offset.

FIG. 10 shows a block diagram of a communications manager that supports configuration and determination of an RB offset for uplink transmission across SBFD and non-SBFD symbols at a device that includes a UE.

FIG. 11 shows a diagram of a system including a device that includes a UE and supports configuration and determination of an RB offset for uplink transmission across SBFD and non-SBFD symbols in accordance with one or more aspects of the present disclosure.

FIG. 12 shows a flowchart illustrating methods that support configuration and determination of an RB offset for uplink transmission across SBFD and non-SBFD symbols.

### DETAILED DESCRIPTION

In some wireless communications systems, a network entity may indicate to a user equipment (UE) a resource allocation for a scheduled message (such as a physical downlink shared channel (PDSCH) or physical uplink shared channel (PUSCH)) via a frequency-domain resource allocation (FDRA) in a control message (such as downlink control information (DCI)). In some examples, the network entity may indicate one or more resource allocations for scheduled messages that include one or more sub-band full duplex (SBFD) orthogonal frequency division multiplexing (OFDM) symbols and non-SBFD OFDM symbols in different slots. SBFD symbols may include one or more sub-bands for uplink transmissions (e.g., PUSCHs) and one or more sub-bands for downlink transmissions (such as PDSCHs), whereas non-SBFD symbols may include uplink bandwidth parts (BWPs) or downlink BWPs.

In some examples, a UE may receive an indication of a first communication scheme where uplink transmissions and downlink receptions are restricted to SBFD symbols only or non-SBFD symbols only. In some other examples, a UE may receive an indication of a second communication scheme where uplink transmissions and downlink receptions may be in SBFD symbols and in non-SBFD symbols. In such examples, the UE may receive a resource allocation indication for non-SBFD symbols and one or more RB offsets to determine a starting resource block (RB) of the resource allocation (such as with respect to a starting RB of the non-SBFD symbols) in the SBFD symbols. However, some other communication systems may not define how to determine the starting RB for SBFD symbols when the RB offset is indicated or how to determine the starting RB when the RB offset is not configured.

Accordingly, techniques described herein may enable a UE to determine and apply one or more RB offsets to an FDRA to determine the starting RB of an uplink transmission occasion (the resource allocation) in an uplink sub-band of SBFD symbols. In some examples, the UE may receive semi-static configuration signaling of the one or more RB offsets. For example, the UE may receive an explicit indication of the RB offset. In another example, the UE may receive semi-static configuration signaling of two or more RB offsets and an indication of which RB offset to apply to determine the starting RB. Additionally, or alternatively, the UE may determine the starting RB based on implicit indication of the RB offset. For example, the UE may determine the RB offset based on a first usable RB or last usable (such as available for uplink communication) physical resource block (PRB) in the uplink sub-band of the SBFD symbols. In some cases, the UE may determine whether to align the starting RB with an RB group (RBG) grid. In some examples, the UE may support contiguous and non-contiguous PRB resource allocations based on a capability of the UE.

In some examples, the UE may receive semi-static configuration signaling explicitly indicating the RB offset. For example, the UE may receive an indication of the RB offset via a radio resource control (RRC) parameter. In some other examples, the UE may receive an indication of the RB offset via downlink control information (DCI). For example, the UE may receive a list of RB offsets via semi-static configuration signaling, and the DCI may indicate which RB offset to use (e.g., using a bitfield in the DCI). The UE may determine the starting RB based on the RB offset and the FDRA. For example, the starting RB may be based on the RB offset, a starting RB of the uplink sub-band of the SBFD symbols, a size of the uplink BWP, or any combination thereof. In some cases, the UE may apply the same starting RB based on the FDRA (e.g., when the RB offset is not configured) or determine the RB offset based on the first RB or last usable PRB in the uplink sub-band of the SBFD symbols. In some examples, the UE may receive an RRC parameter indicating whether the UE determines the starting RB differently in SBFD symbols than in non-SBFD symbols. Additionally, or alternatively, the UE may determine to align the starting RB of the uplink transmission occasion RBG grid. In some cases, the UE may expect that allocated PRBs for the uplink transmission occasion are contiguous when applying a modular operation to determine the starting RB. In some other cases, the UE may support non-contiguous (e.g., almost-contiguous) PRBs based on a capability of the UE. In some examples, the UE may receive an implicit or explicit indication of the RB offset based on the capability of the UE.

Particular aspects of the subject matter described in this disclosure can be implemented to realize one or more of the following potential advantages. In some implementations, by determining the starting RB based on explicit or implicit RB offset configurations, the described techniques may support greater flexibility for the UE to transmit scheduled uplink messages in SBFD symbols. For example, the UE may receive an explicit indication of the RB offset or an implicit indication of the RB offset based on a capability of the UE, and may determine the starting RB for a PUSCH in an uplink sub-band accordingly. Receiving implicit or explicit indications of the RB offset based on UE capability may enable a greater quantity of UEs with different capabilities to implement the described techniques. Additionally, or alternatively, determining the RB offset based on an implicit indication may support reduced signaling overhead at a network entity. The described techniques may support reduced processing at the UE based on indicating whether the UE should determine the starting RB differently in SBFD symbols than the starting RB in non-SBFD symbols via an RRC parameter. In some examples, determining the starting RB for the scheduled uplink messages using the RB offset, the FDRA, the uplink BWP size, or any combination thereof, may support greater flexibility in determining the starting RB and transmitting the uplink messages. In some implementations, the described techniques may support more communication schemes (such as random access type 0 and random access type 1) based on aligning the starting RB with the RBG grid and supporting contiguous and non-contiguous PRBs in accordance with a capability of the UE. For example, rather than dropping the uplink messages, the described techniques enable a UE to transmit the uplink messages when there are non-contiguous PRBs in allocation for the uplink messages based on the UE supporting random access type 0.

Aspects of the disclosure are initially described in the context of wireless communications systems. Aspects of the disclosure are then illustrated by and described with reference to explicit RB offset configurations, implicit RB offset configurations, RB offsets for RBG grids, RB offsets for contiguous and non-contiguous PRB allocations, and a process flow. Aspects of the disclosure are further illustrated by and described with reference to apparatus diagrams, system diagrams, and flowcharts that relate to configuration and determination of resource block offsets for uplink transmission across SBFD and non-SBFD symbols.

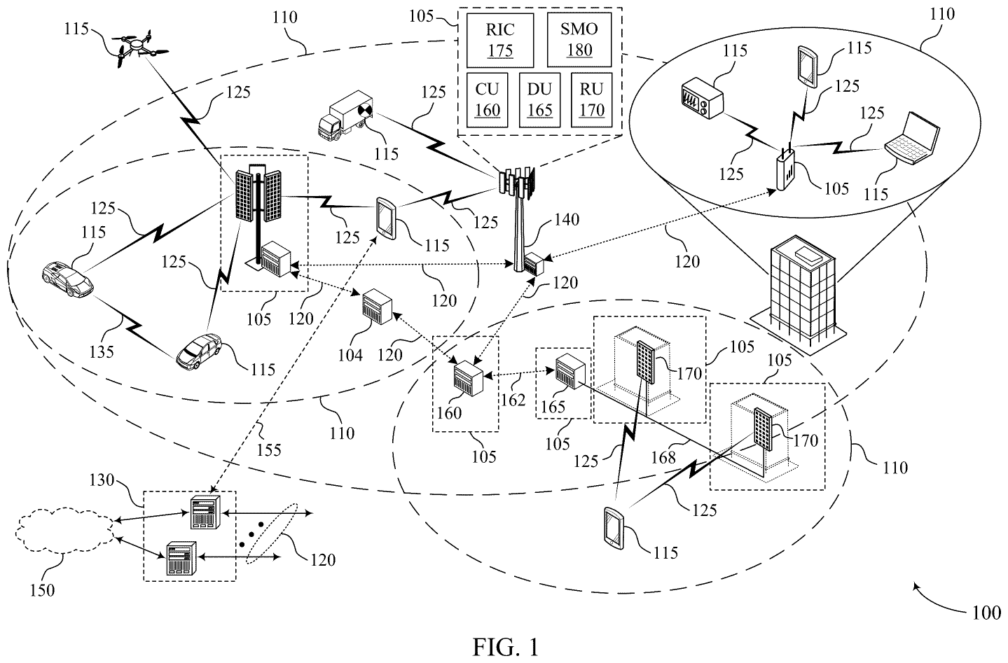

FIG. 1 shows an example of a wireless communications system 100 that supports configuration and determination of RB offsets for uplink transmission across SBFD and non-SBFD symbols in accordance with one or more aspects of the present disclosure. The wireless communications system 100 may include one or more devices, such as one or more network devices (such as network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (such as a radio frequency (RF) access link). For example, a network entity 105 may support a coverage area 110 (such as a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (such as other wireless communication devices, including UEs 115 or network entities 105), as shown in FIG. 1.

As described herein, a node of the wireless communications system 100, which may be referred to as a network node, or a wireless node, may be a network entity 105 (such as any network entity described herein), a UE 115 (such as any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (such as in accordance with an S1, N2, N3, or other interface protocol). In some examples, network entities 105 may communicate with one another via backhaul communication link(s) 120 (such as in accordance with an X2, Xn, or other interface protocol) either directly (such as directly between network entities 105) or indirectly (such as via the core network 130). In some examples, network entities 105 may communicate with one another via a midhaul communication link 162 (such as in accordance with a midhaul interface protocol) or a fronthaul communication link 168 (such as in accordance with a fronthaul interface protocol), or any combination thereof. The backhaul communication link(s) 120, midhaul communication links 162, or fronthaul communication links 168 may be or include one or more wired links (such as an electrical link, an optical fiber link) or one or more wireless links (such as a radio link, a wireless optical link), among other examples or various combinations thereof. A UE 115 may communicate with the core network 130 via a communication link 155.

One or more of the network entities 105 or network equipment described herein may include or may be referred to as a base station 140 (such as a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (such as a base station 140) may be implemented in an aggregated (such as monolithic, standalone) base station architecture, which may be configured to utilize a protocol stack that is physically or logically integrated within one network entity (such as a network entity 105 or a single RAN node, such as a base station 140).

In some examples, a network entity 105 may be implemented in a disaggregated architecture (such as a disaggregated base station architecture, a disaggregated RAN architecture), which may be configured to utilize a protocol stack that is physically or logically distributed among multiple network entities (such as network entities 105), such as an integrated access and backhaul (IAB) network, an open RAN (O-RAN) (such as a network configuration sponsored by the O-RAN Alliance), or a virtualized RAN (vRAN) (such as a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (such as a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (such as separate physical locations). In some examples, one or more of the network entities 105 of a disaggregated RAN architecture may be implemented as virtual units (such as a virtual CU (VCU), a virtual DU (VDU), a virtual RU (VRU)).

The split of functionality between a CU 160, a DU 165, and an RU 170 is flexible and may support different functionalities depending on which functions (such as network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (such as layer 3 (L3), layer 2 (L2)) functionality and signaling (such as Radio Resource Control (RRC), service data adaptation protocol (SDAP), Packet Data Convergence Protocol (PDCP)). The CU 160 (such as one or more CUs) may be connected to a DU 165 (such as one or more DUs) or an RU 170 (such as one or more RUs), or some combination thereof, and the DUs 165, RUs 170, or both may host lower protocol layers, such as layer 1 (L1) (such as physical (PHY) layer) or L2 (such as radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (such as via one or multiple different RUs, such as an RU 170). In some cases, a functional split between a CU 160 and a DU 165 or between a DU 165 and an RU 170 may be within a protocol layer (such as some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (such as F1, F1-c, F1-u), and a DU 165 may be connected to an RU 170 via a fronthaul communication link 168 (such as open fronthaul (FH) interface). In some examples, a midhaul communication link 162 or a fronthaul communication link 168 may be implemented in accordance with an interface (such as a channel) between layers of a protocol stack supported by respective network entities (such as one or more of the network entities 105) that are in communication via such communication links.

In some wireless communications systems (such as the wireless communications system 100), infrastructure and spectral resources for radio access may support wireless backhaul link capabilities to supplement wired backhaul connections, providing an IAB network architecture (such as to a core network 130). In some cases, in an IAB network, one or more of the network entities 105 (such as network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (such as IAB donors) may be in communication with one or more additional devices (such as IAB node(s) 104) via supported access and backhaul links (such as backhaul communication link(s) 120). IAB node(s) 104 may include an IAB mobile termination (IAB-MT) controlled (such as scheduled) by one or more DUs (such as DUs 165) of a coupled IAB donor. An IAB-MT may be equipped with an independent set of antennas for relay of communications with UEs 115 or may share the same antennas (such as of an RU 170) of IAB node(s) 104 used for access via the DU 165 of the IAB node(s) 104 (such as referred to as virtual IAB-MT (vIAB-MT)). In some examples, the IAB node(s) 104 may include one or more DUs (such as DUs 165) that support communication links with additional entities (such as IAB node(s) 104, UEs 115) within the relay chain or configuration of the access network (such as downstream). In such cases, one or more components of the disaggregated RAN architecture (such as the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support configuration and determination of resource block offsets for uplink transmission across sub-band full duplex (SBFD) and non-SBFD symbols as described herein. For example, some operations described as being performed by a UE 115 or a network entity 105 (such as a base station 140) may additionally, or alternatively, be performed by one or more components of the disaggregated RAN architecture (such as components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (such as one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (such as a bandwidth part (BWP)) that is operated according to one or more PHY layer channels for a given RAT (such as LTE, LTE-A, LTE-A Pro, NR). Each PHY layer channel may carry acquisition signaling (such as synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (such as entity, sub-entity) of a network entity 105. For example, the terms “transmitting,” “receiving,” or “communicating,” when referring to a network entity 105, may refer to any portion of a network entity 105 (such as a base station 140, a CU 160, a DU 165, a RU 170) of a RAN communicating with another device (such as directly or via one or more other network entities, such as one or more of the network entities 105).

The communication link(s) 125 of the wireless communications system 100 may include downlink transmissions (such as forward link transmissions) from a network entity 105 to a UE 115, uplink transmissions (such as return link transmissions) from a UE 115 to a network entity 105, or both, among other configurations of transmissions. Carriers may carry downlink or uplink communications (such as in an FDD mode) or may be configured to carry downlink and uplink communications (such as in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (such as 1.4, 3, 5, 10, 15, 20, 40, or 80 megahertz (MHz)). Devices of the wireless communications system 100 (such as the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (such as a sub-band, a BWP) or all of a carrier bandwidth.

Signal waveforms transmitted via a carrier may be made up of multiple subcarriers (such as using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (such as a duration of one modulation symbol) and one subcarrier, in which case the symbol period and subcarrier spacing may be inversely related. The quantity of bits carried by each resource element may depend on the modulation scheme (such as the order of the modulation scheme, the coding rate of the modulation scheme, or both), such that a relatively higher quantity of resource elements (such as in a transmission duration) and a relatively higher order of a modulation scheme may correspond to a relatively higher rate of communication. A wireless communications resource may refer to a combination of an RF spectrum resource, a time resource, and a spatial resource (such as a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (such as 10 milliseconds (ms)). Each radio frame may be identified by a system frame number (SFN) (such as ranging from 0 to 1023).

Each frame may include multiple consecutively-numbered subframes or slots, and each subframe or slot may have the same duration. In some examples, a frame may be divided (such as in the time domain) into subframes, and each subframe may be further divided into a quantity of slots. Alternatively, each frame may include a variable quantity of slots, and the quantity of slots may depend on subcarrier spacing. Each slot may include a quantity of symbol periods (such as depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (such as N_{f}) sampling periods. The duration of a symbol period may depend on the subcarrier spacing or frequency band of operation.

A subframe, a slot, a mini-slot, or a symbol may be the smallest scheduling unit (such as in the time domain) of the wireless communications system 100 and may be referred to as a transmission time interval (TTI). In some examples, the TTI duration (such as a quantity of symbol periods in a TTI) may be variable. Additionally, or alternatively, the smallest scheduling unit of the wireless communications system 100 may be dynamically selected (such as in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (such as a control resource set (CORESET)) for a physical control channel may be defined by a set of symbol periods and may extend across the system bandwidth or a subset of the system bandwidth of the carrier. One or more control regions (such as CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (such as control channel elements (CCEs)) associated with encoded information for a control information format having a given payload size. Search space sets may include common search space sets configured for sending control information to UEs 115 (such as one or more UEs) or may include UE-specific search space sets for sending control information to a UE 115 (such as a specific UE).

In some examples, a network entity 105 (such as a base station 140, an RU 170) may be movable and therefore provide communication coverage for a moving coverage area, such as the coverage area 110. In some examples, coverage areas 110 (such as different coverage areas) associated with different technologies may overlap, but the coverage areas 110 (such as different coverage areas) may be supported by the same network entity (such as a network entity 105). In some other examples, overlapping coverage areas, such as a coverage area 110, associated with different technologies may be supported by different network entities (such as the network entities 105). The wireless communications system 100 may include, for example, a heterogeneous network in which different types of the network entities 105 support communications for coverage areas 110 (such as different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (such as one or more of the UEs 115) via a device-to-device (D2D) communication link, such as a D2D communication link 135 (such as in accordance with a peer-to-peer (P2P), D2D, or sidelink protocol). In some examples, one or more UEs 115 of a group that are performing D2D communications may be within the coverage area 110 of a network entity 105 (such as a base station 140, an RU 170), which may support aspects of such D2D communications being configured by (such as scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (such as a mobility management entity (MME), an access and mobility management function (AMF)) and at least one user plane entity that routes packets or interconnects to external networks (such as a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (such as base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (such as less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (such as LAA). Operations using unlicensed spectrum may include downlink transmissions, uplink transmissions, P2P transmissions, or D2D transmissions, among other examples.

A network entity 105 (such as a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (such as a network entity 105, a UE 115) to shape or steer an antenna beam (such as a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (such as with respect to the antenna array of the transmitting device or receiving device, or with respect to some other orientation).

In some wireless communications systems, a network entity 105 may indicate, to a UE 115, a resource allocation for a scheduled message (such as a PDSCH or PUSCH) via an FDRA in a control message (such as DCI). In some examples, the network entity 105 may indicate one or more resource allocations for scheduled messages across one or more SBFD symbols and non-SBFD symbols in different slots. SBFD symbols may include one or more sub-bands for uplink transmissions (e.g., PUSCHs) and one or more sub-bands for downlink transmissions (such as PDSCHs), whereas non-SBFD symbols may include uplink BWPs or downlink BWPs.

In some examples, a UE 115 may receive an indication of a first communication scheme where uplink transmissions and downlink receptions are restricted to SBFD symbols only or non-SBFD symbols only. In some other examples, a UE 115 may receive an indication of a second communication scheme where uplink transmissions and downlink receptions may be in SBFD symbols and in non-SBFD symbols. In such examples, the UE 115 may receive a resource allocation indication for non-SBFD symbols and one or more RB offsets to determine a starting RB of the resource allocation (such as a PUSCH) in the SBFD symbols. However, some other communication systems may not define how to determine the starting RB when the RB offset is indicated or how to determine the starting RB when the RB offset is not configured.

Accordingly, techniques described herein may enable a UE 115 to determine and apply one or more RB offsets to an FDRA to determine the starting RB of an uplink transmission occasion (the resource allocation) in an uplink sub-band of SBFD symbols. In some examples, the UE 115 may receive semi-static configuration signaling of the one or more RB offsets. For example, the UE 115 may receive an explicit indication of the RB offset. In another example, the UE 115 may receive semi-static configuration signaling of two or more RB offsets and an indication of which RB offset to apply to determine the starting RB. Additionally, or alternatively, the UE 115 may determine the starting RB based on implicit indication of the RB offset. For example, the UE 115 may determine the RB offset based on a first or last usable (such as available for uplink communication) PRB in the uplink sub-band of the SBFD symbols. In some cases, the UE 115 may determine whether to align the starting RB with an RBG grid. In some examples, the UE 115 may support contiguous and non-contiguous PRB resource allocations based on a capability of the UE 115.

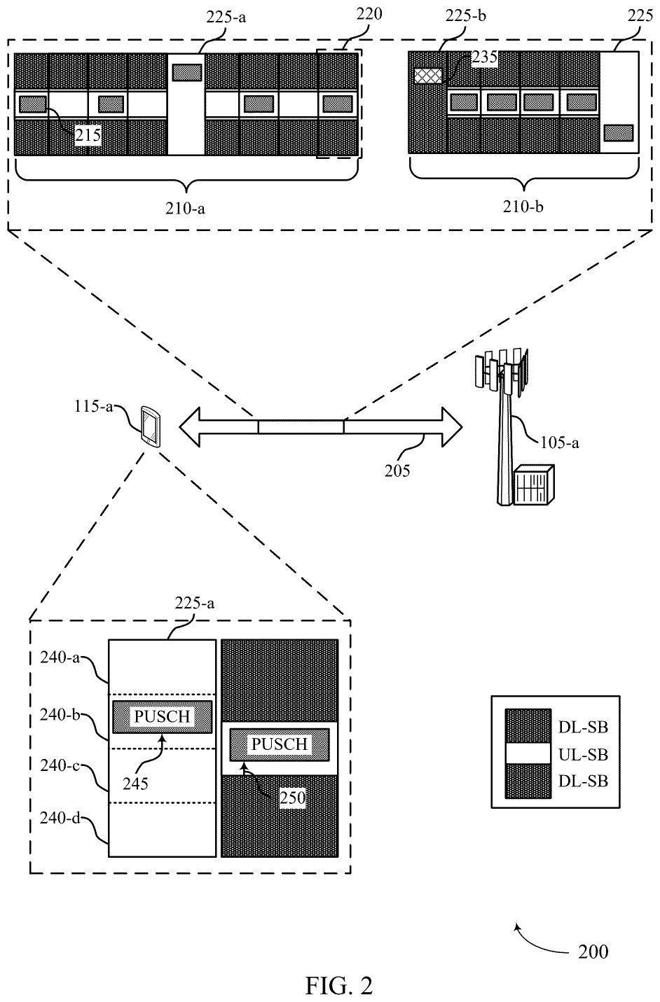

FIG. 2 shows an example of a wireless communications system 200 that supports configuration and determination of RB offsets for uplink transmission across SBFD and non-SBFD symbols in accordance with one or more aspects of the present disclosure. The wireless communications system 200 may implement, or may be implemented by, aspects of the wireless communications system 100, as described with reference to FIG. 1. For example, the wireless communications system 200 may include a UE 115-a and a network entity 105-a, which may be examples of the corresponding devices described herein, including with reference to FIG. 1.

In some examples, the UE 115-a may receive one or more downlink transmissions, transmit one or more uplink transmissions, or both, via a communication link 205 (such as a communication link 125). For example, the UE 115-a may transmit one or more uplink messages 215 via one or more uplink transmission occasions and receive one or more control messages 235. Each of the one or more control messages 235 may include downlink control information (DCI). The UE 115-a and the network entity 105-a may communicate via the communication link 205 using one or more SBFD symbols 220, one or more non-SBFD symbols 225, or both. The one or more SBFD symbols 220 may include one or more downlink sub-bands (DL-SBs) and one or more uplink sub-bands (UL-SBs). The one or more non-SBFD symbols 225 may include one or more uplink BWPs 225-a and one or more downlink BWPs 225-b, in which the UE 115-a may transmit messages to the network entity 105-a or receive messages from the network entity 105-b, respectively.

For uplink transmissions and downlink receptions across SBFD symbols 220 and non-SBFD symbols 225 in different slots (each transmission and/or reception within a slot may have all SBFD or all non-SBFD symbols) the UE 115-a (such as an SBFD aware UE) may be provided (such as from the network entity 105-a) with a respective communication scheme (such as configuration 1 or configuration 2). For a first communication scheme (such as configuration 1), transmissions and receptions may be limited to SBFD symbols 220 only or to non-SBFD symbols 225 only. For example, the network entity 105-a may schedule some uplink transmission occasions (such as one or more PUSCHs) only in an uplink slot for SBFD symbols 220 and other uplink transmission occasions only in an uplink slot for non-SBFD symbols 225. In some cases, such as PUSCH repetition type A with available slot counting, transport block processing over multi-slot PUSCH (TBoMS), and PUCCH repetitions, the UE 115-a may postpone transmissions for invalid symbol types in accordance with the first communication scheme. In some other cases, the UE 115-a may drop transmissions, receptions, or both, for invalid symbol types in accordance with the first communication scheme.

In a second communication scheme, transmissions and receptions may be in SBFD symbols 220 and in non-SBFD symbols 225. That is, the second communication scheme may enable transmissions across different SBFD symbols 220 and non-SBFD symbols 225. In a first example 210-a, a configured grant PUSCH (CG PUSCH) may configure periodic PUSCH transmission occasions in accordance with a periodicity. For example, the UE 115-a may receive an RRC message or DCI from the one or more control messages 235. In a transmission example 210-b, the UE 115-a may receive an indication (such as the one or more control messages 235) to transmit multiple uplink transmissions via the one or more PUSCHs. For example, (such as for PUSCH repetition type-A), the UE 115-a may receive an indication that indicates the UE 115-a to transmit the same transport block (TB) multiple times (to improve coverage). In another example, such as for multi-PUSCH scheduled by a single DCI, the UE 115-a may receive DCI that indicates the UE 115-a to transmit multiple TBs in SBFD symbols 220 and non-SBFD symbols 225.

In some other wireless communications systems, a UE 115 may receive the same frequency domain resource allocation (FDRA) to transmit the one or more uplink messages 215 in accordance with any of the examples 210. In some examples, some FDRAs may be unavailable (based on wideband allocation for multiple UEs), and the UE may receive a configuration or indication for non-SBFD symbols 225 and one or more RB offset configurations or indications to determine an FDRA for SBFD symbols 220. However, other wireless communications systems may not define how a UE 115 may determine the FDRA for non-SBFD symbols 225. The other wireless communications systems may also not enable the UE 115 to determine the FDRA for non-SBFD symbols 225 in cases where an RB offset is not configured.

The techniques described herein may enable the UE 115-a to apply one or more RB offsets 250 to an FDRA to determine a starting RB of an uplink transmission occasion in an uplink sub-band of the SBFD symbols 220. In some cases, the UE 115-a may receive an explicit or implicit indication of the RB offset 250 based on a signaled capability of the UE 115-a to support explicit or implicit RB offsets. In some examples, the UE 115-a may receive semi-static configuration signaling of the one or more RB offsets 250 via the communication link 205. In a first example, the UE 115-a may receive a configuration of a single RB offset 250 for PUSCH transmission occasions in SBFD symbols 220 (such as for a type 1 CG PUSCH with configuration 2). In the first example, the UE 115-a may receive the configuration via an RRC parameter in an uplink grant configuration (such as rre-ConfiguredUplinkGrant in ConfiguredGrantConfig).

In a second example, the UE 115-a may receive a list of one or more RB offsets 250 for PUSCH transmission occasions in SBFD symbols 220 (such as by an RRC parameter in PUSCH-Config). In the second example, the UE 115-a may receive DCI that indicates which RB offset 250 to apply. For example, the DCI may include a bitfield indicator (such as when list >1 value of RB offset) for the UE 115-a to determine the RB offset 250. In some cases, the bitfield indicator may explicitly indicate which RB offset to apply. Additionally, or alternatively, the UE 115-a may determine the RB offset based on a frequency hopping (FH) indicator, such as when FH is configured for the one or more uplink messages 215. For example, one or more bits in DCI for the FH indicator may indicate FH and one or more bits may indicate the RB offsets 250. In another example, the bitfield indicator of the FH offset indicator may be re-used to indicate the RB offsets 250. In some other cases, the UE 115-a may determine an implicit RB offset 250 based on the FDRA (such as based on a starting RB or quantity of RBs compared to a threshold).

For example, the uplink BWP 225-a may be divided into four partitions 240 (first partition 240-a, second partition 240-b, third partition 240-c, and fourth partition 240-d) equal in size to the uplink sub-band in the SBFD symbols 220. The UE 115-a may select an RB offset 250 based on a location of a starting RB in the uplink BWP 225-a. That is, each partition 240 may correspond to a respective RB offset 250, and the UE 115-a may select the RB offset 250 based on which partition 240 includes the starting RB. For example, the UE 115-a may select the RB offset 250 based on the starting RB being in the second partition 240-b. Additionally, or alternatively, the UE 115-a may select (implicitly determine) the RB offset 250 based on determining an offset 245 from the start of a respective partition. For example, the UE 115-a may apply an RB offset 250 that is equal to the offset 245.

In some other examples, the uplink BWP 225-a may be partitioned into N partitions 240 based on a quantity of configured RB-offsets. For example, when 4 RB-offsets are configured, the uplink BWP 225-a may be partitioned into four partitions 240, and the UE 115-a may select one of the RB offsets based on which quarter of the uplink BWP 225-a the start-RB in the non-SBFD symbol is in. Table 1 illustrates an example for a list of four RB-offsets and implicit determination based on the size of the uplink BWP 223-a,

$${N}_{BWP}^{size} .$$

TABLE 1

| RB-start in non-SBFD symbols | RB-offset |
|---|---|
| ${RB}_{start} < \frac{{N}_{BWP}^{size}}{4}$ | RB-offset 1 |
| $\frac{{N}_{BWP}^{size}}{4} \leq {RB}_{start} < \frac{{N}_{BWP}^{size}}{2}$ | RB-offset 2 |
| $\frac{{N}_{BWP}^{size}}{2} \leq {RB}_{start} < \frac{3 {N}_{BWP}^{size}}{4}$ | RB-offset 3 |
| $\frac{3 {N}_{BWP}^{size}}{4} \leq {RB}_{start}$ | RB-offset 4 |

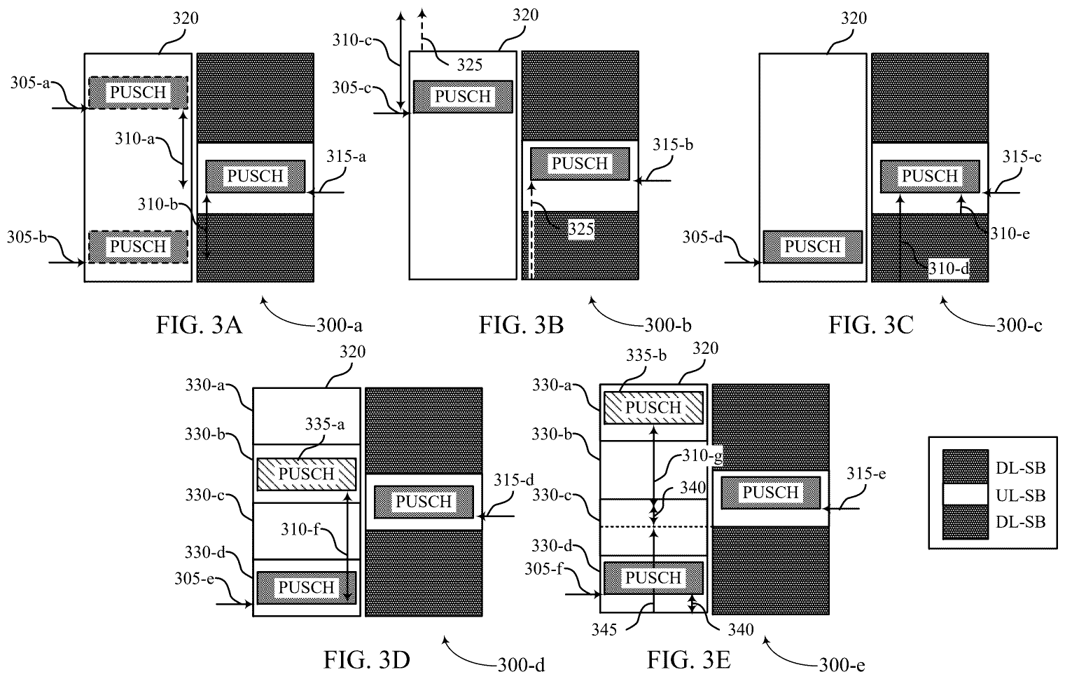

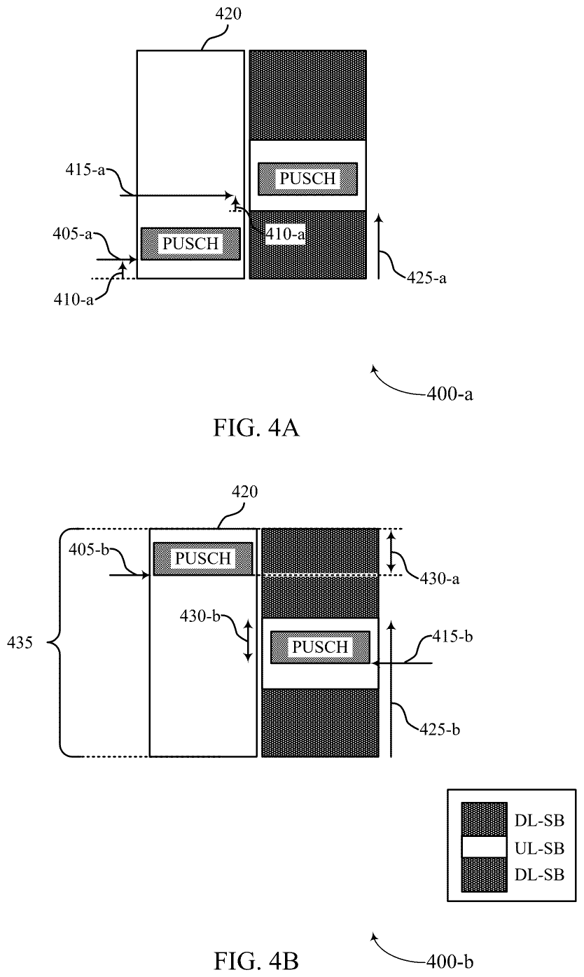

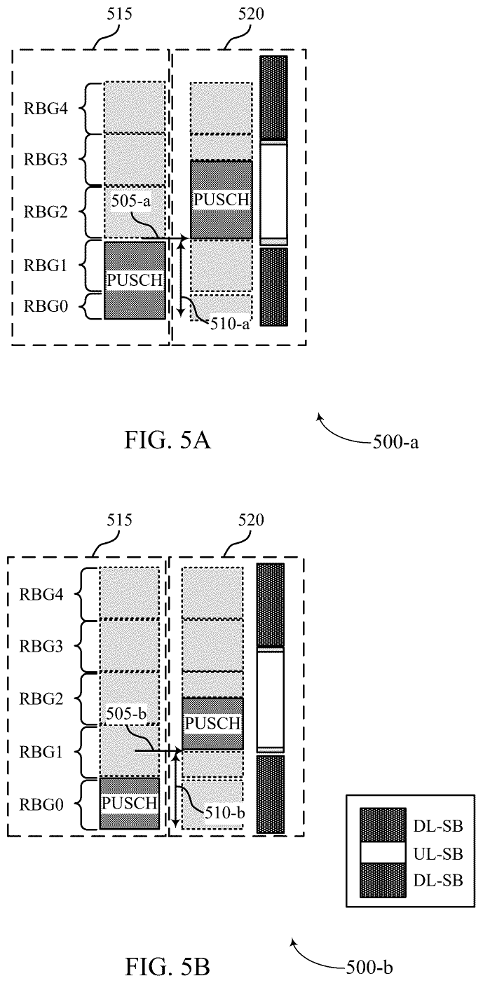

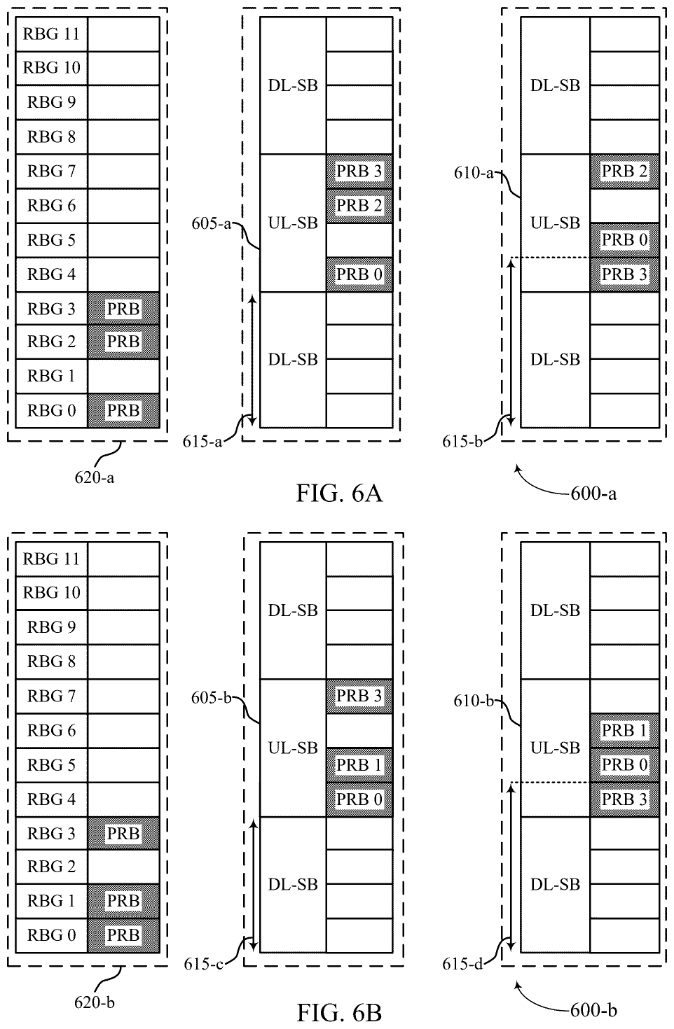

As described further with reference to FIGS. 3A through 3E, the UE 115-a may select a starting RB of a PUSCH transmission occasion based on the RB offset 250 (a configured or determined RB offset), a starting RB of the FDRA in the uplink BWP 225-a (the PUSCH in the uplink BWP 225-a), and a size of the physical resource block (PRB) of the FDRA. Additionally, or alternatively, as described further with reference to FIGS. 4A and 4B, the UE 115-a may set the RB offset 250 to zero or determine the RB offset 250 based on a first usable or last usable PRB in the uplink sub-band of the SBFD symbols 220 (such as when the RB offset 250 is not configured). As described herein, a “usable” PRB may refer to a PRB available for uplink communications (opposed to a downlink sub-band which may be “unusable” for uplink communications). In some examples, as described further with reference to FIGS. 5A and 5B, the UE 115-a may apply the RB offset 250 to align a starting RB of the PUSCH transmission occasion in the uplink sub-band with an RBG grid associated with the communication link 205. Additionally, or alternatively, the UE 115-a may support contiguous and non-contiguous PRB allocations based on a capability of the UE 115-a, as described further with reference to FIGS. 6A and 6B.

FIGS. 3A through 3E show examples of explicit RB offset configurations 300 that support configuration and determination of RB offsets for uplink transmission across SBFD and non-SBFD symbols in accordance with one or more aspects of the present disclosure. In some examples, the explicit RB offset configurations 300 may implement, or be implemented by, aspects of the wireless communications system 100 or the wireless communications system 200, as described with reference to FIGS. 1 and 2. In the examples of FIGS. 3A through 3E, a UE (such as a UE 115) may receive an FDRA (a PUSCH) in an uplink BWP 320 from a network entity (such as a network entity 105). The UE may determine a starting RB 315 of an uplink transmission occasion (a PUSCH) in an uplink sub-band of an SBFD symbol based on the FDRA, an RB offset 310, and a starting RB 305 of the FDRA in the uplink BWP 320. In some examples, the UE may receive a configuration or indication of the RB offset 310, as described herein (such as with reference to FIG. 2).

FIG. 3A illustrates a first RB offset configuration 300-a. The UE may determine the starting RB 315-a according to equation 1:

$${RB}_{start} ( SBFD ) = {RB}_{start} + {RB}_{offset} \qquad ( 1 )$$

where RBₛₜₐᵣₜ(SBFD) is the starting RB 315-a, RBₛₜₐᵣₜ is the starting RB 305-a or the starting RB 305-b, and RB_{offset} is the RB offset 310-a or RB offset 310-b. The RB offset 310 may have a positive or negative value, and the RB offset 310 may span a range of PRBs in the uplink BWP 320. For example, for the starting RB 305-a, the RB offset 310-a may be negative. For the starting RB 305-b, the RB offset 310-b may be positive.

Additionally, or alternatively, the UE may determine the starting RB 315 according to equation 2:

$${RB}_{start} ( SBFD ) = {RB}_{start} \pm {RB}_{offset} \qquad ( 2 )$$

where the RB offset 310 is a positive value (such as 1 to the maximum quantity of PRBs), and the sign of RB offset 310 in equation 2 is based on the FDRA (such as RB start, RB end < > threshold). For example, the starting RB 305-a may be compared to an ending RB of the uplink BWP 320 based on a threshold (such as half the BWP size), and the UE may determine to subtract or add the RB offset 310 based on satisfying the threshold (such as add the RB offset if the starting RB 305-a is below half the BWP size or subtract the RB offset if the starting RB 305-b is above half the BWP size).

FIG. 3B illustrates a second RB offset configuration 300-b. The UE may determine the starting RB 315-b according to equation 3:

$${RB}_{start} ( SBFD ) = ( {RB}_{start} + {RB}_{offset} ) mod {N}_{BWP}^{size} \qquad ( 3 )$$

where RBₛₜₐᵣₜ(SBFD) is the starting RB 315-b, RBₛₜₐᵣₜ is the starting RB 305-c, RB_{offset} is the RB offset 310-c, and N is the size, in PRBs, of the uplink BWP 320. The starting RB 315-b may be determined with respect to the uplink BWP 320 frequency range, and the RB offset 310-c may be positive offsets spanning the range of the uplink BWP 320 (such as 0 to N−1 PRBs). For example, based on equation 3, if the sum of the starting RB 305-c and the RB offset 310-c is outside of the frequency range of the uplink BWP 320, the RB offset 310-c may “wrap around” the uplink BWP 320. For example, the RB offset 310-c may extend a distance 325 outside the uplink BWP 320, and the starting RB 315-b may begin the distance 325 from a first RB of the SBFD symbol in accordance with equation 3.

FIG. 3C illustrates a third RB offset configuration 300-c. The UE may determine the starting RB 315-c according to equation 4:

$${RB}_{start} ( SBFD ) = {RB}_{offset} \qquad ( 4 )$$

where RBₛₜₐᵣₜ(SBFD) is the starting RB 315-c and RB_{offset} is the RB offset 310-d or the RB offset 310-e. In a first example of the third RB offset configuration 300-c, the RB offset 310-d may be with respect to the uplink BWP 320 PRBs (such as the starting RB 305-d and/or 0 to

$${N}_{BWP}^{size} - 1 values ) .$$

In some examples, the network entity may configure the RB offset 310-d within the uplink sub-band PRBs based on the UE using the third RB offset configuration 300-c. In a second example of the third RB offset configuration 300-c, the RB offset 310-e may be with respect to a first usable PRB (such as first PRB available for PUSCH transmission) in the uplink sub-band. In some examples, the RB offset 310-e may range from 0 to

$${N}_{SB}^{size} - 1 values .$$

In some examples, the starting RB 315 may be based on a scaled integer quantity given by a ratio of the uplink sub-band and the uplink BWP 320. For example, the UE may determine the starting RB according to equation 5:

$$R {B}_{start} ( SBFD ) = \frac{R {B}_{start}}{K} \qquad ( 5 )$$

where RBₛₜₐᵣₜ(SBFD) is the starting RB 315, RBₛₜₐᵣₜ is the starting RB 305, and K is the ratio of the uplink sub-band to uplink BWP 320 (such as floor or ceiling or round

$$\frac{{N}_{BWP}^{size}}{{N}_{SB}^{size}} ) .$$

In such examples, the starting RB 315 may be with respect to a first starting RB in the uplink sub-band. For example, for a ratio of 4 between the uplink BWP size to uplink sub-band size, dividing the starting RB 315 by four may result in RBs 0 to 3 of the uplink BWP 320 mapping to the first RB in the uplink sub-band.

FIG. 3D illustrates a fourth RB offset configuration 300-d. The UE may determine the starting RB 315-d according to equation 6:

$${RB}_{start} ( SBFD ) = ( {RB}_{start} + {RB}_{offset} ) mod {N}_{SB}^{size} \qquad ( 6 )$$

where RBₛₜₐᵣₜ(SBFD) is the starting RB 315-d, RBₛₜₐᵣₜ is the starting RB 305-e, RB_{offset} is the RB offset 310-f, and N is the size, in PRBs, of the uplink sub-band. The RB offset 310-f may be a positive value spanning the range of the uplink sub-band (such as 0 to N−1 of the uplink sub-band), and the UE may determine the starting RB 315-d with respect to the first usable PRB in the uplink sub-band. For example, the UE may partition the uplink BWP 320 into one or more partitions 330, where each partition 330 is the same size as the uplink sub-band. In accordance with equation 6, the sum of the starting RB 305-e and the RB offset 310-f may result in a PUSCH occasion 335-a in the second partition 330-b. The difference between a starting RB of the PUSCH occasion 335-a and the boundary of the second partition 330-b may be the RB offset between the first usable PRB in the uplink sub-band and the starting RB 315-d in the SBFD symbol.

FIG. 3E illustrates a fifth RB offset configuration 300-e. The UE may determine the starting RB 315-e according to equation 7 or equation 8:

$${RB}_{start} ( SBFD ) = ( {RB}_{start} - {start}_{RB}^{SB} + {RB}_{offset} ) mod {N}_{SB}^{size} \qquad ( 7 )$$

$${RB}_{start} = ( SBFD ) = ( {RB}_{start} + {start}_{RB}^{SB} + {RB}_{offset} ) mod {N}_{SB}^{size} \qquad ( 8 )$$

where RBₛₜₐᵣₜ(SBFD) is the starting RB 315-e, RBₛₜₐᵣₜ is the starting RB 305-f, RB_{offset} is the RB offset 310-g, start

$$\begin{matrix}SB \\ RB\end{matrix}$$

is tie starting uplink sub-band KB 345, and N is the size, in PRBs, of the uplink sub-band. For example, the starting RB 305-f may be offset a distance 340 from the start of the uplink BWP 320. The distance 340 may be added to the starting uplink sub-band RB 345 and to the RB offset 310-g, which may result in the PUSCH occasion 335-b being in the first partition 330-a. The difference between a starting RB of the PUSCH occasion 335-b and the boundary of the first partition 330-a may be the RB offset between the first usable PRB in the uplink sub-band and the starting RB 315-e in the SBFD symbol.

FIGS. 4A and 4B show examples of implicit RB offset configurations 400 that support configuration and determination of RB offsets for uplink transmission across SBFD and non-SBFD symbols in accordance with one or more aspects of the present disclosure. In some examples, the implicit RB offset configurations 400 may implement, or be implemented by, aspects of the wireless communications system 100 or the wireless communications system 200, as described with reference to FIGS. 1 and 2. In the examples of FIGS. 4A and 4B, a UE (such as a UE 115) may receive an FDRA (a PUSCH) in an uplink BWP 420 from a network entity (such as a network entity 105). The UE may determine a starting RB 415 of an uplink transmission occasion (a PUSCH) in an uplink sub-band of an SBFD symbol based on the FDRA, an RB offset, a first usable PRB in the uplink sub-band or a last usable PRB in the uplink sub-band, or any combination thereof.

In some examples, the UE may apply a same starting RB 415 based on the FDRA in non-SBFD symbols, such as the uplink BWP 420 (all start RBs for SBFD and non-SBFD symbols may be the same), and the RB offset may be zero. In such examples, the UE may drop the PUSCH if one of the PRBs (of the PUSCH occasion) is outside the uplink sub-band, including PUSCH repetitions with physical slot counting (slot counted and PUSCH is dropped). Additionally, or alternatively, such as for PUSCH repetition and TBoMS with available slot counting, the UE may postpone uplink transmission via the PUSCH if one PRB of the PUSCH is outside the useable uplink sub-band (slot is not counted). In some cases, the UE may determine the starting RB 415 based on any of equations 1 through 8, but with RB offset set to zero.

FIG. 4A illustrates a first RB offset configuration 400-a. The UE may determine the starting RB 415-a based on a first usable PRB in accordance with the first RB offset configuration 400-a. For example, if the UE determines that the RB offset 425-a is the first PRB of the uplink sub-band, the starting RB 415-a of the PUSCH in the SBFD symbol may be based on RBₛₜₐᵣₜ+X, where X is the index of the first PRB in the uplink sub-band. That is, the starting RB 415-a may be a sum of the distance 410-a from the starting RB of the uplink BWP 420 to the starting RB 405-a and the RB offset 425-a.

FIG. 4B illustrates a second RB offset configuration 400-b. The UE may determine the starting RB 415-b based on a last usable PRB of the uplink sub-band in accordance with the second RB offset configuration 400-b. For example, if the UE determines that the RB offset 425-b is the last PRB of the uplink sub-band, the starting RB 415-b of the PUSCH in the SBFD symbol may be based on

$${X}_{e n d} - ( {N}_{BWP}^{s i z e} - 1 - R {B}_{start} ) ,$$

where X is the index of the last PRB in the uplink sub-band within the uplink BWP 420 (RB offset 425-b), N is the size 435, in PRBs, of the uplink BWP 420, and RBₛₜₐᵣₜ is the starting RB 405-b. That is, the distances 430-a and 430-b may be

$${N}_{BWP}^{size} - 1 - R {B}_{start} .$$

Whether the UE determines the starting RB 415 relative to a first usable PRB or last usable PRB may be based on the starting RB 405 of the scheduled or configured PUSCH. In some examples, the UE may determine a single RB offset (X=RB_{offset}) based on the first usable RB or last usable PRB in the uplink sub-band. For example, the UE may determine the starting RB 415 in the SBFD symbol with respect to the offset using modular operation of the sub-band size in accordance with equation 6 or equation 7. Additionally, or alternatively, the UE may interpret the starting RB 415 with respect to the first PRB in the usable uplink sub-band.

In some examples, the UE may receive an RRC parameter indicating whether the UE should determine the starting RB 415 differently in SBFD symbols than a starting RB in non-SBFD symbols. For example, if the RRC parameter is indicated, the UE may determine the RB offset with respect to the uplink sub-band. If the RRC parameter is not indicated (such as absent or not configured), the UE may apply a same starting RB offset in SBFD symbols.

FIGS. 5A and 5B show examples of RB offsets for RBG grids 500 that support configuration and determination of RB offsets for uplink transmission across SBFD and non-SBFD symbols in accordance with one or more aspects of the present disclosure. In some examples, the RB offsets for RBG grids 500 may implement, or be implemented by, aspects of the wireless communications systems, explicit RB offset configurations, or implicit RB offset configurations described with reference to FIGS. 1 through 4B. In the examples of FIGS. 5A and 5B, a UE (such as a UE 115) may receive an FDRA (a PUSCH) in an uplink BWP 515 from a network entity (such as a network entity 105). The UE may determine a starting RB 505 of an uplink transmission occasion (a PUSCH) in an uplink sub-band of an SBFD symbol 520 based on an RBG grid.

In some examples, such as for random access type 1, a resource indicator value (RIV) for DCI format 0_2 may indicate a starting RBG and a set of contiguous virtual resource block groups (LRBGs) that may be interleaved or non-interleaved at an RBG granularity. That is, if

$$( {L}_{RBGBs} - 1 ) \leq [ \frac{{N}_{RBGB}}{2} ] ,$$

then RIV=N_{RBGB}(L_{RBGBS}−1)+RBGₛₜₐᵣₜ. Otherwise, RIV=N_{RBGB}(N_{RBG}−L_{RGBS}−1)+(N_{RBG}−1−RBGₛₜₐᵣₜ), where L_{RBGBs}≥1 and may not exceed N_{RBG}−RBGₛₜₐᵣₜ. In some examples, the RBG size may be P=2, 4, 8, or 16, where a first and last RBG may be partial (such as RBG 0 or RBG 4). Additionally, or alternatively, an indication of RBs for random access type 0 may be based on RBGs. For example, the network entity may partition the uplink BWP 515 into multiple RBGs in accordance with a bitmap. Each bit may assign an RBG for PUSCH scheduling. In some other wireless communications systems, it may be undefined whether to align the RB offset 510 with the RBG grid (such as for type 1 or type 0).

FIG. 5A illustrates a first example RB offset for an RBG grid 500-a. The UE may determine the starting RB 505-a based on the frequency resource of the PUSCH in the SBFD symbols 520 being based on RBGs (such as a bitmap for RA type 0 or RIV with RBG granularity). For example, the UE may determine the RB offset 510-a according to equation 9:

$${RB}_{offset} = n \times {RBG}_{size} \qquad ( 9 )$$

where n is the quantity of RBGs from RBG 0 of the uplink BWP 515 to RBG n in which the PUSCH in the uplink sub-band is aligned. That is, the starting RB 505-a may be aligned with the RBG grid granularity in SBFD symbols 520, which may avoid extra (such as in addition to a first or last RBG) partial RBGs within the uplink BWP 515. In some cases, the first RBG in the uplink BWP 515 may be partial (such as in FIG. 5A) or the first RBG in the uplink sub-band may be partial. In such cases, the starting RB 505-a may be a non-integer quantity of PRBs (such as 1.5 RBGs) to align with the RBG grid in SBFD symbols 520.

FIG. 5B illustrates a second example RB offset for an RBG grid 500-b. The UE may determine the starting RB 505-b based on the frequency resource of the PUSCH in the SBFD symbols 520 being based on RBGs (such as a bitmap for RA type 0 or RIV with RBG granularity). For example, the RB offset 510-b may be arbitrary (with respect to the RBG grid). That is, the starting RB 505-b may not align with the RBG grid (enabling partial RBGs other than the first or last RBG).

FIGS. 6A and 6B show examples of RB offsets for contiguous and non-contiguous PRB allocations 600 that support configuration and determination of RB offsets for uplink transmission across SBFD and non-SBFD symbols in accordance with one or more aspects of the present disclosure. In some examples, the RB offsets for contiguous and non-contiguous PRB allocations 600 may implement, or be implemented by, aspects of the wireless communications systems, explicit RB offset configurations, implicit RB offset configurations, or RB offsets for RBG grids described with reference to FIGS. 1 through 5B. In the examples of FIGS. 6A and 6B, a UE (such as a UE 115) may receive an FDRA (a PUSCH including one or more PRBs) in an uplink BWP 620 from a network entity (such as a network entity 105).

In some examples, the FDRA may be contiguous (such as no spacing between PRBs of the PUSCH) and there may be no virtual RB (VRB) and PRB interleaving (such as in random access type 1). For example, the UE may expect that allocated PRBs are contiguous when the UE applies modular operation (such as in equations 6, 7, or 8) for determining the starting RB of the PUSCH in SBFD symbols. In some cases, if the ending RB of the PUSCH is outside of the uplink sub-band, the UE may drop or postpone PUSCH transmissions, as described further with reference to FIGS. 4A and 4B. That is, the UE may not apply warp around for the remaining PRBs.

In some other examples, the FDRA may be non-contiguous (“almost-contiguous”) based on a capability of the UE (such as for random access type 0). For example, non-contiguous FDRAs may be enabled for cyclic prefix-OFDM in frequency range 1 (FR1) based on UE capability. In such other examples,

$$\frac{{RBs}_{gap}}{{RBs}_{gap} + {RBs}_{FDRA}} \leq 25 \% ,$$

where RBs_{gap} is a quantity of VRBs between PRBs in the uplink BWP 620. The techniques described herein may support at least random access type 1, random access type 0, or both (such as when the UE does not support ‘almost-contiguous’ PRBs). Based on the UE supporting non-contiguous PRBs (such as ‘almost contiguous’ PRBs), the UE may determine an RB offset 615 such that all PRBs, including gap PRBs, may be in the uplink sub-band. Additionally, or alternatively, the UE may apply wrap-around if the ratio of gap RBs to total RBs in the uplink sub-band is the same as the ratio of gap RBs to total RBs in the uplink BWP 620.

FIG. 6A illustrates first examples of RB offset for non-contiguous PRB allocations 600-a. For example, the UE may receive non-contiguous PRB allocations at RBG 0, RBG 2, and RBG 3 in the uplink BWP 620-a. In a first example, the UE may determine the RB offset 615-a such that all of the PRBs, including the gap PRB (such as the gap corresponding to RBG 1) are within the uplink sub-band 605-a. In a second example, the UE may determine the RB offset 615-b such that the ratio of gap RBs to total RBs is the same in the uplink sub-band and in the uplink sub-band 610-a. For example, the UE may apply the RB offset 615-b to determine a starting RB for the uplink sub-band 610-a. The UE may apply wrap-around based on the RB offset 615-b shifting PRB 3 out of the uplink sub-band 610-a. That is, PRB 3 may wrap around from the end of the uplink sub-band 610-a to the beginning of the uplink sub-band 610-a.

FIG. 6B illustrates second examples of RB offset for non-contiguous PRB allocations 600-b. For example, the UE may receive non-contiguous PRB allocations at RBG 0, RBG 1, and RBG 3 in the uplink BWP 620-b. In a first example, the UE may determine the RB offset 615-c in such that all of the PRBs, including the gap PRB (such as the gap corresponding to RBG 2) are within the uplink sub-band 605-b. In a second example, the UE may determine the RB offset 615-d such that the ratio of gap RBs to total RBs is the same in the uplink sub-band and in the uplink sub-band 610-b. For example, the UE may apply the RB offset 615-d to determine a starting RB for the uplink sub-band 610-b. The UE may apply wrap-around based on the RB offset 615-d shifting PRB 3 out of the uplink sub-band 610-b. That is, PRB 3 may wrap around from the end of the uplink sub-band 610-b to the beginning of the uplink sub-band 610-b. The UE may apply the wrap around based on the ratio of gap RBs to total RBs remaining the same. That is, although the PRBs in the uplink sub-band 610-b become contiguous based on the RB offset 615-d, ratio of gap RBs to total RBs (such as 1:3) remains the same in the uplink sub-band 610-b.

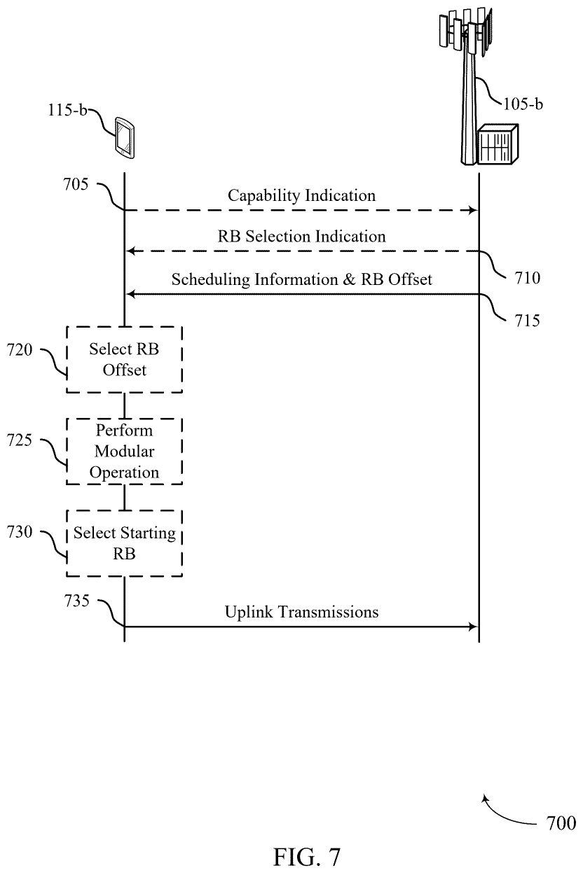

FIG. 7 shows an example of a process flow 700 that supports configuration and determination of RB offsets for uplink transmission across SBFD and non-SBFD symbols in accordance with one or more aspects of the present disclosure. The process flow 700 may implement or be implemented by aspects of any of the wireless communications systems, explicit RB offset configurations, implicit RB offset configurations, RB offsets for RBG grids, or RB offsets for contiguous and non-contiguous PRB allocations as described with reference to FIGS. 2 through 6B. For example, the process flow 700 includes a network entity 105-b and a UE 115-b, which may be examples of corresponding devices described herein, including with reference to FIGS. 1 and 2. In the following description of the process flow 700, operations between the network entity 105-b and the UE 115-b may be added, omitted, or performed in a different order (with respect to the order shown).

At 705, the UE 115-b may transmit an indication of a capability of the UE 115-b to support determining a starting RB of one or more uplink transmissions of multiple uplink transmissions within one or more RBs of an uplink sub-band during one or more SBFD symbols according to an RB offset.

In some examples, at 710, the UE 115-b may receive an indication associated with selecting the starting RB with respect to the uplink sub-band during the one or more SBFD symbols or selecting the starting RB in accordance with a second starting RB during one or more non-SBFD symbols. That is, the indication may indicate whether to determine the starting RB differently in SBFD symbols than starting RBs in non-SBFD symbols.

At 715, the UE 115-b may receive an indication of scheduling information (such as a CG-PUSCH or dynamic grant (DG) PUSCH) for the multiple uplink transmissions via one or more SBFD symbols and one or more non-SBFD symbols and an RB offset associated with an FDRA of the scheduling information. In some examples, the RB offset may define a location of the starting RB, as described further with reference to FIGS. 3A through 6B. In some cases, the UE 115-b may receive the indication of the RB offset in accordance with the capability of the UE 115-b. In some examples, receiving the indication of the scheduling information may include receiving semi-static signaling (explicitly) indicating the RB offset. Additionally, or alternatively, the UE 115-b may set the RB offset to zero in accordance with a detected absence of an explicit RB offset in the scheduling information. The uplink transmission may be semi-statically configured by higher layer (e.g., configured-grant PUSCH) or dynamically scheduled by DCI. Examples of the uplink transmission across SBFD and non-SBFD may include PUSCH Type-A repetition, PUSCH Type B repetition, PUSCH TBoMS, CG-PUSCH or multiple PUSCHs by single DCI, msg3 PUSCH or msgA PUSCH.

At 720, the UE 115-b may select an RB offset of multiple RB offsets for the one or more uplink transmissions of the multiple uplink transmissions. For example, the UE 115-b may receive semi-static signaling indicating multiple configured RB offsets at 715. In some examples, the semi-static signaling may include DCI indicating an RB offset of the multiple configured RB offsets, and the UE 115-b may select the RB offset indicated in the DCI.

In some examples, at 725, the UE 115-b may perform a modular operation in accordance with the RB offset, a first RB of the uplink sub-band, and a size of the uplink sub-band during the one or more SBFD symbols. In such examples, the RB offset may be a positive value spanning a range of RBs in the uplink sub-band. Additionally, or alternatively, the UE 115-b may perform a modular operation to determine the starting RB in accordance with a contiguity of one or more PRBs of the FDRA.

At 730, the UE 115-b may select the location of the starting RB. In a first example, the UE 115-b may select the location of the starting RB in accordance with a combination of the RB offset and a first RB of the uplink sub-band during the one or more SBFD symbols. In a second example, the UE 115-b may select the location of the starting RB in accordance with applying the RB offset to a first PRB defined for the uplink sub-band during the one or more SBFD symbols or to a first PRB for an uplink BWP. In a third example, the UE 115-b may select the location of the starting RB in accordance with a first RB of the uplink sub-band during the one or more SBFD symbols and a size of the uplink sub-band to an uplink BWP. In some examples, the UE 115-b may select the location of the starting RB in accordance with the modular operation (such as the modular operation in accordance with the RB offset, the first RB of the uplink sub-band, and the size of the uplink sub-band).

In some other examples, the UE 115-b may select the location of the starting RB in accordance with a first RB or a last PRB in the uplink sub-band during the one or more SBFD symbols. Additionally, or alternatively, the UE 115-b may select the starting RB with respect to the uplink sub-band during the one or more SBFD symbols in accordance with receiving the indication of selecting the starting RB with respect to the uplink sub-band or selecting the starting RB in accordance with the second starting RB during the one or more non-SBFD symbols. In some examples, the UE 115-b may select the starting RB to align the starting RB with an RBG grid associated with the one or more SBFD symbols, as described further with reference to FIGS. 5A and 5B.

At 735, the UE 115-b may transmit, via the uplink sub-band, the multiple uplink transmissions in accordance with the scheduling information and the RB offset. In some examples, multiple PRBs associated with the FDRA may be within the uplink sub-band during the one or more SBFD symbols. Additionally, or alternatively, the FDRA may include one or more gap RBs associated with a second set of uplink transmissions, and a ratio of the one or more gap RBs to a total quantity of RBs of the FDRA may be constant, as described further with reference to FIGS. 6A and 6B.

As additional examples, a UE may receive an indication of a first communication scheme where uplink transmissions and downlink receptions are restricted to SBFD symbols only or non-SBFD symbols only. In some other examples, a UE may receive an indication of a second communication scheme where uplink transmissions and downlink receptions may be in SBFD symbols and in non-SBFD symbols. In the second communication scheme, the UE may receive a single FDRA for non-SBFD symbols (e.g., which may use the full uplink BWP for sending uplink transmissions) and for SBFD symbols (e.g., within the uplink sub-bands of the SBFD symbols). Without a mechanism to support mapping the FDRA between non-SBFD symbols and SBFD symbols, the UE may drop one or more of the uplink transmissions (e.g., if the non-SBFD allocation may not fit within the SBFD uplink sub-band) or may be limited to transmitting the uplink transmissions in accordance with the first communication scheme, thereby reducing scheduling flexibility and spectrum efficiency. In such examples, the UE may receive a resource allocation indication for non-SBFD symbols and one or more RB offsets to determine a starting resource block (RB) of the resource allocation (such as with respect to a starting RB of the non-SBFD symbols) in the SBFD symbols. However, some other communication systems may not define how to determine the starting RB for SBFD symbols when the RB offset is indicated or how to determine the starting RB when the RB offset is not configured.

As another additional example, in a second communication scheme, transmissions and receptions may be in SBFD symbols 220 and in non-SBFD symbols 225. That is, the second communication scheme may enable transmissions across different SBFD symbols 220 and non-SBFD symbols 225. In a first example 210-a, a configured grant PUSCH (CG PUSCH) may configure periodic PUSCH transmission occasions in accordance with a periodicity. For example, the UE 115-a may receive an RRC message or DCI in one or more control messages 235 that indicate resources and the periodicity for the periodic PUSCH transmission. In a transmission example 210-b, the UE 115-a may receive an indication (such as the one or more control messages 235) to transmit multiple uplink transmissions via the one or more PUSCHs. For example, (such as for PUSCH repetition type-A), the UE 115-a may receive an indication that indicates the UE 115-a to transmit the same transport block (TB) multiple times (to improve coverage). In another example, such as for multi-PUSCH scheduled by a single DCI, the UE 115-a may receive DCI that indicates the UE 115-a to transmit multiple TBs in SBFD symbols 220 and non-SBFD symbols 225.

As another additional example, the techniques described herein may enable the UE 115-a to apply one or more RB offsets 250 to an FDRA to determine a starting RB of an uplink transmission occasion in an uplink sub-band of the SBFD symbols 220. In some cases, the UE 115-a may receive an explicit or implicit indication of the RB offset 250 based on a signaled capability of the UE 115-a to support explicit or implicit RB offsets. In some examples, the UE 115-a may receive semi-static configuration signaling of the one or more RB offsets 250 via the communication link 205. In a first example, the UE 115-a may receive a configuration of a single RB offset 250 for PUSCH transmission occasions in SBFD symbols 220 (such as for a type 1 CG PUSCH (i.e. CG PUSCH that does not use a MAC or PHY layer trigger to transmit PUSCH) with configuration 2). In the first example, the UE 115-a may receive the configuration via an RRC parameter in an uplink grant configuration (such as rrc-ConfiguredUplinkGrant in ConfiguredGrantConfig).

As another additional example, (such as for PUSCH scheduled by DCI and type 2 CG PUSCH (e.g., CG PUSCH that uses a MAC or PHY layer trigger to transmit PUSCH) with configuration 2) the UE 115-a may receive a list of one or more RB offsets 250 for PUSCH transmission occasions in SBFD symbols 220 (such as by an RRC parameter in PUSCH-Config). In the second example, the UE 115-a may receive DCI that indicates which RB offset 250 to apply. For example, the DCI may include a bitfield indicator (such as when list >1 value of RB offset) for the UE 115-a to determine the RB offset 250. In some cases, the bitfield indicator may explicitly indicate which RB offset to apply. Additionally, or alternatively, the UE 115-a may determine the RB offset based on a frequency hopping (FH) indicator, such as when FH is configured for the one or more uplink messages 215. For example, one or more bits in DCI for the FH indicator may indicate FH and one or more bits may indicate the RB offsets 250. In another example, the bitfield indicator of the FH offset indicator may be re-used to indicate the RB offsets 250. In some other cases, the UE 115-a may determine an implicit RB offset 250 based on the FDRA (such as based on a starting RB or quantity of RBs compared to a threshold).

As another additional example, the UE may determine the starting RB 315-d according to equation 6:

$${RB}_{start} ( SBFD ) = ( {RB}_{start} + {RB}_{offset} ) mod {N}_{SB}^{size} \qquad ( 6 )$$

where RBₛₜₐᵣₜ(SBFD) is the starting RB 315-d, RBₛₜₐᵣₜ is the starting RB 305-e, RB_{offset} is the RB offset 310-f, and N is the size, in PRBs, of the uplink sub-band. The RB offset 310-f may be a positive value spanning the range of the uplink sub-band (such as 0 to N−1 of the uplink sub-band), and the UE may determine the starting RB 315-d with respect to the first usable PRB in the uplink sub-band. For example, the UE may partition the uplink BWP 320 into one or more partitions 330, where each partition 330 is the same size as the uplink sub-band. In accordance with equation 6, the modulus of the sum of the starting RB 305-e and the RB offset 310-f with respect to the size of PRBs of the uplink sub-band may result in a PUSCH occasion 335-a in the second partition 330-b. The difference between a starting RB of the PUSCH occasion 335-a and the boundary of the second partition 330-b may be the RB offset between the first usable PRB in the uplink sub-band and the starting RB 315-d in the SBFD symbol.

As another additional example, the UE may determine the starting RB 315-e according to equation 7 or equation 8:

$${RB}_{start} ( SBFD ) = ( {RB}_{start} - {start}_{RB}^{SB} + {RB}_{offset} ) mod {N}_{SB}^{size} \qquad ( 7 )$$

$${RB}_{start} = ( SBFD ) = ( {RB}_{start} + {start}_{RB}^{SB} + {RB}_{offset} ) mod {N}_{SB}^{size} \qquad ( 8 )$$

where RBₛₜₐᵣₜ(SBFD) is the starting RB 315-e, RBₛₜₐᵣₜ is the starting RB 305-f, RB_{offset} is the RB offset 310-g, start_{RB}^{SB} is the starting uplink sub-band RB 345, and N is the size, in PRBs, of the uplink sub-band. For example, the starting RB 305-f may be offset a distance 340 from the start of the uplink BWP 320. The distance 340 may be added to the starting uplink sub-band RB 345 and to the RB offset 310-g, which may result in a notional PUSCH occasion 335-b being in the first partition 330-a. The difference between a starting RB of the PUSCH occasion 335-b and the boundary of the first partition 330-a may be the RB offset between the first usable PRB in the uplink sub-band and the starting RB 315-e in the SBFD symbol.

As another additional example, the RB offsets for RBG grids 500 may implement, or be implemented by, aspects of the wireless communications systems, explicit RB offset configurations, or implicit RB offset configurations described with reference to FIGS. 1 through 4B. In the examples of FIGS. 5A and 5B, a UE (such as a UE 115) may receive an FDRA (a PUSCH) in an uplink BWP 515 from a network entity (such as a network entity 105). The UE may determine a starting RB 505 of an uplink transmission occasion (a PUSCH) in an uplink sub-band of an SBFD symbol 520 based on an RBG grid. For example, the UE may determine the starting RB 505 based on a starting PRB index of the RBG grid.

As another additional example, such as for random access type 1, a resource indicator value (RIV) for DCI format 0_2 may indicate a starting RBG and a set of contiguous virtual resource block groups (LRBGs) that may be interleaved or non-interleaved at an RBG granularity. That is, if

$$( {L}_{RGBs} - 1 ) \leq [ \frac{{N}_{RGB}}{2} ] ,$$

then RIV=N_{RGB}(L_{RGBS}−1)+RBGₛₜₐᵣₜ. Otherwise, RIV=N_{RGB}(N_{RBG}−L_{RGBS}−1)+(N_{RBG}−1−RBGₛₜₐᵣₜ), where L_{RGBS}≥1 and may not exceed N_{RBG}−RBGₛₜₐᵣₜ. In some examples, the RBG size may be P=2, 4, 8, or 16, where a first and last RBG may be partial (such as RBG 0 or RBG 4). Additionally, or alternatively, an indication of RBs for random access type 0 may be based on RBGs. For example, the network entity may partition the uplink BWP 515 into multiple RBGs in accordance with a bitmap. Each bit may assign an RBG for PUSCH scheduling. In some other wireless communications systems, it may be undefined whether to align the RB offset 510 with the RBG grid (such as for type 1 or type 0).

As another additional example, the UE may receive non-contiguous PRB allocations at RBG 0, RBG 2, and RBG 3 in the uplink BWP 620-a. In a first example, the UE may determine the RB offset 615-a such that all of the PRBs, including the gap PRB (such as the gap corresponding to RBG 1) are within the uplink sub-band 605-a. In a second example, the UE may determine the RB offset 615-b such that the ratio of gap RBs to total RBs is the same in the uplink sub-band 605-a and in the uplink sub-band 610-a. For example, the UE may apply the RB offset 615-b to determine a starting RB for the uplink sub-band 610-a. The UE may apply wrap-around based on the RB offset 615-b shifting PRB 3 out of the uplink sub-band 610-a. That is, PRB 3 may wrap around from the end of the uplink sub-band 610-a to the beginning of the uplink sub-band 610-a.

As another additional example, the UE may receive non-contiguous PRB allocations at RBG 0, RBG 1, and RBG 3 in the uplink BWP 620-b. In a first example, the UE may determine the RB offset 615-c such that all of the PRBs, including the gap PRB (such as the gap corresponding to RBG 2) are within the uplink sub-band 605-b. In a second example, the UE may determine the RB offset 615-d such that the ratio of gap RBs to total RBs is the same in the uplink sub-band 605-b and in the uplink sub-band 610-b. For example, the UE may apply the RB offset 615-d to determine a starting RB for the uplink sub-band 610-b. The UE may apply wrap-around based on the RB offset 615-d shifting PRB 3 out of the uplink sub-band 610-b. That is, PRB 3 may wrap around from the end of the uplink sub-band 610-b to the beginning of the uplink sub-band 610-b. The UE may apply the wrap around based on the ratio of gap RBs to total RBs remaining the same. That is, although the PRBs in the uplink sub-band 610-b become contiguous based on the RB offset 615-d, ratio of gap RBs to total RBs (such as 1:3) remains the same in the uplink sub-band 610-b.

As another additional example, at 720, the UE 115-b may select an RB offset of multiple RB offsets for the one or more uplink transmissions of the multiple uplink transmissions. For example, the UE 115-b may receive semi-static signaling indicating multiple configured RB offsets at 715. In some examples, the semi-static (e.g., dynamic) signaling may include DCI indicating an RB offset of the multiple configured RB offsets, and the UE 115-b may select the RB offset indicated in the DCI.

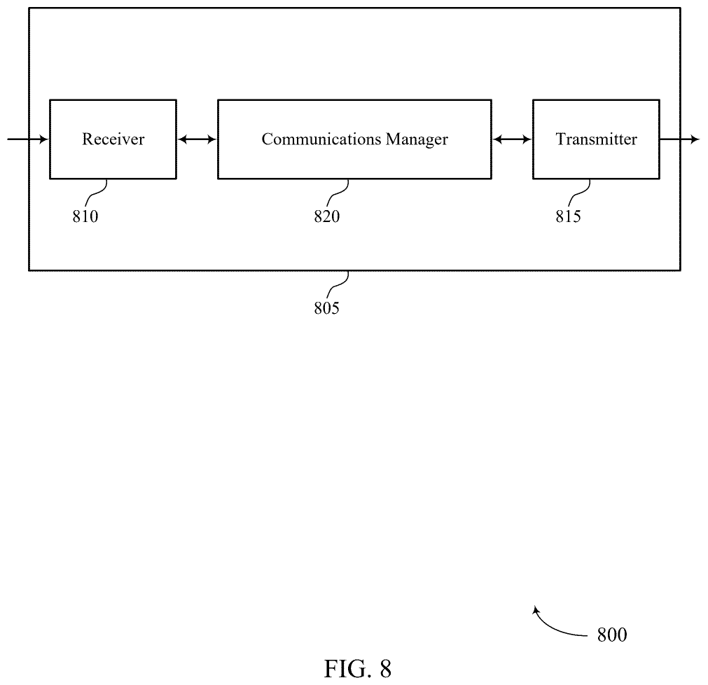

FIG. 8 shows a block diagram 800 of a device 805 that supports configuration and determination of RB offsets for uplink transmission across SBFD and non-SBFD symbols in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (such as the receiver 810, the transmitter 815, the communications manager 820), may include at least one processor, which may be coupled with at least one memory, to, individually or collectively, support or enable the described techniques. Each of these components may be in communication with one another (such as via one or more buses).

The receiver 810 may provide a means for receiving information such as packets, user data, control information, or any combination thereof associated with various information channels (such as control channels, data channels, information channels related to configuration and determination of RB offsets for uplink transmission across SBFD and non-SBFD symbols). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (such as control channels, data channels, information channels related to configuration and determination of RB offsets for uplink transmission across SBFD and non-SBFD symbols). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of configuration and determination of RB offsets for uplink transmission across SBFD and non-SBFD symbols as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (such as in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (such as by one or more processors, individually or collectively, executing instructions stored in the at least one memory).

Additionally, or alternatively, the communications manager 820, the receiver 810, the transmitter 815, or various combinations or components thereof may be implemented in code (such as communications management software or firmware) executed by at least one processor (such as referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (such as configured as or otherwise supporting, individually or collectively, a means for performing the functions described in the present disclosure).

In some examples, the communications manager 820 may be configured to perform various operations (such as receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for receiving an indication of scheduling information for a set of multiple uplink transmissions via one or more SBFD symbols and one or more non-SBFD symbols and an RB offset associated with an FDRA of the scheduling information, where the RB offset indicates a location of a starting RB of one or more uplink transmissions of the set of multiple uplink transmissions within one or more RBs of an uplink sub-band during the one or more SBFD symbols. The communications manager 820 is capable of, configured to, or operable to support a means for transmitting, via the uplink sub-band, the set of multiple uplink transmissions in accordance with the scheduling information and the RB offset.

By including or configuring the communications manager 820 in accordance with examples as described herein, the device 805 (such as at least one processor controlling or otherwise coupled with the receiver 810, the transmitter 815, the communications manager 820, or a combination thereof) may support techniques for more efficient utilization of communication resources, among other examples.

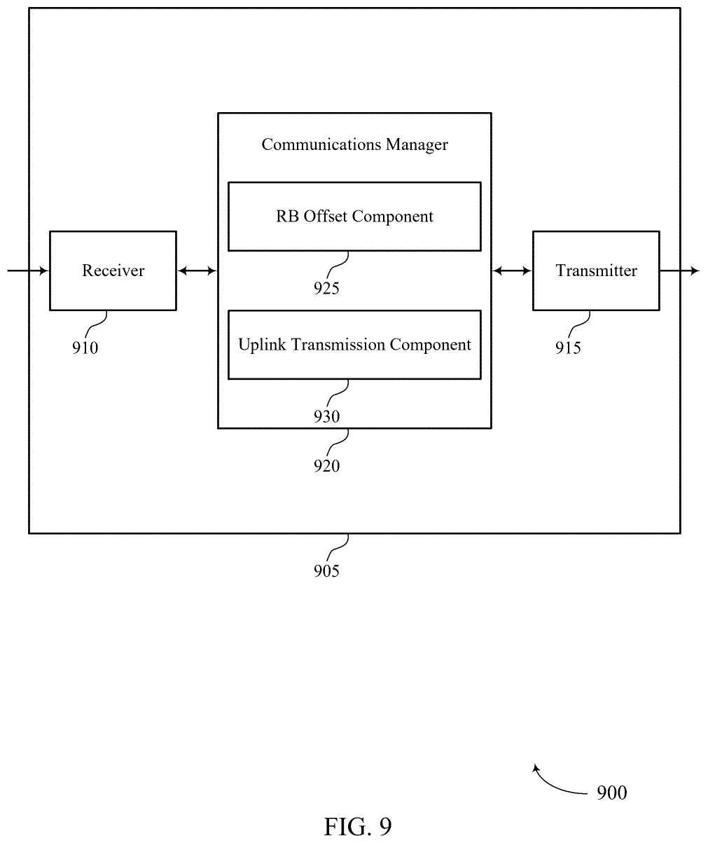

FIG. 9 shows a block diagram 900 of a device 905 that supports configuration and determination of RB offsets for uplink transmission across SBFD and non-SBFD symbols in accordance with one or more aspects of the present disclosure. The device 905 may be an example of aspects of a device 805 or a UE 115 as described herein. The device 905 may include a receiver 910, a transmitter 915, and a communications manager 920. The device 905, or one or more components of the device 905 (such as the receiver 910, the transmitter 915, the communications manager 920), may include at least one processor, which may be coupled with at least one memory, to support the described techniques. Each of these components may be in communication with one another (such as via one or more buses).

The receiver 910 may provide a means for receiving information such as packets, user data, control information, or any combination thereof associated with various information channels (such as control channels, data channels, information channels related to configuration and determination of RB offsets for uplink transmission across SBFD and non-SBFD symbols). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (such as control channels, data channels, information channels related to configuration and determination of RB offsets for uplink transmission across SBFD and non-SBFD symbols). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of configuration and determination of RB offsets for uplink transmission across SBFD and non-SBFD symbols as described herein. For example, the communications manager 920 may include an RB offset component 925 an uplink transmission component 930, or any combination thereof. The communications manager 920 may be an example of aspects of a communications manager 820 as described herein. In some examples, the communications manager 920, or various components thereof, may be configured to perform various operations (such as receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The RB offset component 925 is capable of, configured to, or operable to support a means for receiving an indication of scheduling information for a set of multiple uplink transmissions via one or more SBFD symbols and one or more non-SBFD symbols and an RB offset associated with an FDRA of the scheduling information, where the RB offset indicates a location of a starting RB of one or more uplink transmissions of the set of multiple uplink transmissions within one or more RBs of an uplink sub-band during the one or more SBFD symbols. The uplink transmission component 930 is capable of, configured to, or operable to support a means for transmitting, via the uplink sub-band, the set of multiple uplink transmissions in accordance with the scheduling information and the RB offset.

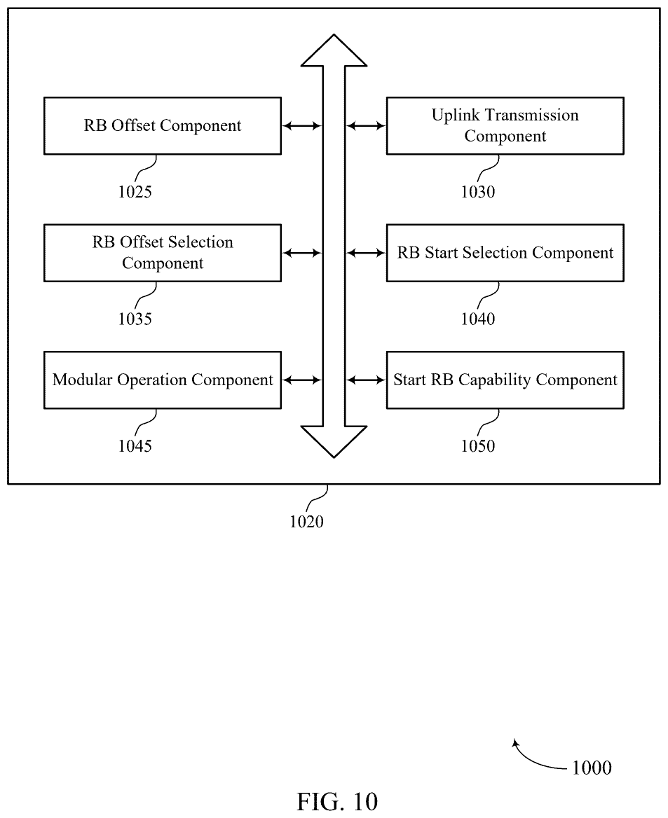

FIG. 10 shows a block diagram 1000 of a communications manager 1020 that supports configuration and determination of RB offsets for uplink transmission across SBFD and non-SBFD symbols in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of configuration and determination of RB offsets for uplink transmission across SBFD and non-SBFD symbols as described herein. For example, the communications manager 1020 may include an RB offset component 1025, an uplink transmission component 1030, an RB offset selection component 1035, an RB start selection component 1040, a modular operation component 1045, a start RB capability component 1050, or any combination thereof. Each of these components, or components or subcomponents thereof (such as one or more processors, one or more memories), may communicate, directly or indirectly, with one another (such as via one or more buses).

The communications manager 1020 may support wireless communications in accordance with examples as disclosed herein. The RB offset component 1025 is capable of, configured to, or operable to support a means for receiving an indication of scheduling information for a set of multiple uplink transmissions via one or more SBFD symbols and one or more non-SBFD symbols and an RB offset associated with an FDRA of the scheduling information, where the RB offset indicates a location of a starting RB of one or more uplink transmissions of the set of multiple uplink transmissions within one or more RBs of an uplink sub-band during the one or more SBFD symbols. The uplink transmission component 1030 is capable of, configured to, or operable to support a means for transmitting, via the uplink sub-band, the set of multiple uplink transmissions in accordance with the scheduling information and the RB offset.

In some examples, to support receiving the indication of the scheduling information, the RB offset component 1025 is capable of, configured to, or operable to support a means for receiving semi-static signaling indicating the RB offset. In some examples, to support receiving the indication of the scheduling information, the RB offset component 1025 is capable of, configured to, or operable to support a means for receiving semi-static signaling indicating a set of multiple configured RB offsets. In some examples, to support receiving the indication of the scheduling information, the RB offset selection component 1035 is capable of, configured to, or operable to support a means for selecting an RB offset of the set of multiple configured RB offsets for the one or more uplink transmissions of the set of multiple uplink transmissions.

In some examples, to support selecting the RB offset of the set of multiple configured RB offsets, the RB offset selection component 1035 is capable of, configured to, or operable to support a means for receiving DCI indicating the RB offset of the set of multiple configured RB offsets. In some examples, the RB start selection component 1040 is capable of, configured to, or operable to support a means for selecting the location of the starting RB in accordance with a combination of the RB offset and a first RB of the uplink sub-band during the one or more SBFD symbols. In some examples, the RB start selection component 1040 is capable of, configured to, or operable to support a means for selecting the location of the starting RB in accordance with applying the RB offset to a first PRB defined for the uplink sub-band during the one or more SBFD symbols or to a first PRB for an uplink BWP.

In some examples, the RB start selection component 1040 is capable of, configured to, or operable to support a means for selecting the location of the starting RB in accordance with a first RB of the uplink sub-band during the one or more SBFD symbols and a size of the uplink sub-band to an uplink BWP.

In some examples, the modular operation component 1045 is capable of, configured to, or operable to support a means for performing a modular operation in accordance with the RB offset, a first RB of the uplink sub-band, and a size of the uplink sub-band during the one or more SBFD symbols, where the RB offset is a positive value spanning a range of RBs of the uplink sub-band. In some examples, the RB start selection component 1040 is capable of, configured to, or operable to support a means for selecting the location of the starting RB in accordance with the modular operation.

In some examples, to support receiving the indication of the scheduling information, the RB offset component 1025 is capable of, configured to, or operable to support a means for setting the RB offset to zero in accordance with a detected absence of an explicit RB offset in the scheduling information. In some examples, the RB start selection component 1040 is capable of, configured to, or operable to support a means for selecting the location of the starting RB in accordance with a first RB or a last PRB in the uplink sub-band during the one or more SBFD symbols.

In some examples, the RB offset component 1025 is capable of, configured to, or operable to support a means for receiving an indication associated with selecting the starting RB with respect to the uplink sub-band during the one or more SBFD symbols or selecting the starting RB in accordance with a second starting RB during the one or more non-SBFD symbols. In some examples, the RB start selection component 1040 is capable of, configured to, or operable to support a means for selecting the starting RB with respect to the uplink sub-band during the one or more SBFD symbols in accordance with receiving the indication. In some examples, the RB start selection component 1040 is capable of, configured to, or operable to support a means for selecting the starting RB to align the starting RB with a RBG grid associated with the one or more SBFD symbols.

In some examples, the modular operation component 1045 is capable of, configured to, or operable to support a means for performing a modular operation to determine the starting RB in accordance with a contiguity of one or more PRBs of the FDRA.

In some examples, a set of multiple PRBs associated with the FDRA are within the uplink sub-band during the one or more SBFD symbols. In some examples, a ratio of the one or more gap RBs to a total quantity of RBs of the FDRA is constant. In some examples, the start RB capability component 1050 is capable of, configured to, or operable to support a means for transmitting an indication of a capability of the UE to support determining the starting RB according to the RB offset, where receiving the indication of the RB offset is in accordance with the capability of the UE.

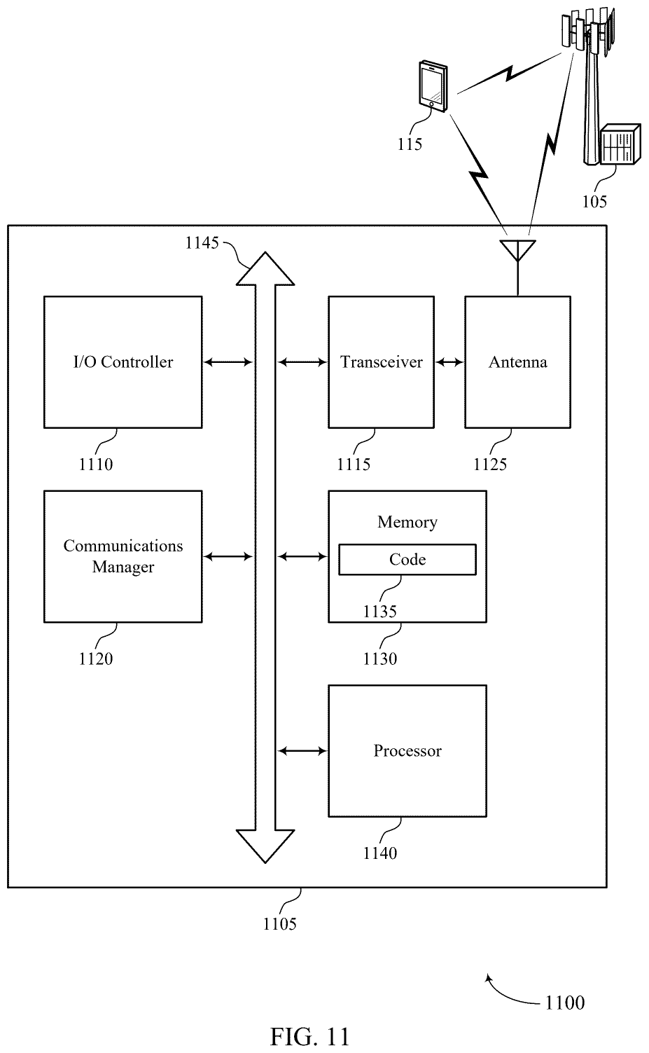

FIG. 11 shows a diagram of a system 1100 including a device 1105 that supports configuration and determination of RB offsets for uplink transmission across SBFD and non-SBFD symbols in accordance with one or more aspects of the present disclosure. The device 1105 may be an example of or include components of a device 805, a device 905, or a UE 115 as described herein. The device 1105 may communicate (such as wirelessly) with one or more other devices (such as network entities 105, UEs 115, or a combination thereof). The device 1105 may include components for bi-directional voice and data communications including components for transmitting and receiving communications, such as a communications manager 1120, an input/output (I/O) controller, such as an I/O controller 1110, a transceiver 1115, one or more antennas 1125, at least one memory 1130, code 1135, and at least one processor 1140. These components may be in electronic communication or otherwise coupled (such as operatively, communicatively, functionally, electronically, electrically) via one or more buses (such as a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna. However, in some other cases, the device 1105 may have more than one antenna, which may be capable of concurrently transmitting or receiving multiple wireless transmissions. The transceiver 1115 may communicate bi-directionally via the one or more antennas 1125 using wired or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (such as when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include one or more intelligent hardware devices (such as one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (such as the at least one memory 1130) to cause the device 1105 to perform various functions (such as functions or tasks supporting configuration and determination of RB offsets for uplink transmission across SBFD and non-SBFD symbols). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some implementations, one or more of the multiple memories may be configured to store processor-executable code that, when executed, may configure one or more of the multiple processors to perform various functions described herein (as part of a processing system). In some other implementations, the processing system may be pre-configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code 1135 (such as processor-executable code) stored in the at least one memory 1130 or otherwise, to perform one or more of the functions described herein.

The communications manager 1120 may support wireless communications in accordance with examples as disclosed herein. For example, the communications manager 1120 is capable of, configured to, or operable to support a means for receiving an indication of scheduling information for a set of multiple uplink transmissions via one or more SBFD symbols and one or more non-SBFD symbols and an RB offset associated with an FDRA of the scheduling information, where the RB offset indicates a location of a starting RB of one or more uplink transmissions of the set of multiple uplink transmissions within one or more RBs of an uplink sub-band during the one or more SBFD symbols. The communications manager 1120 is capable of, configured to, or operable to support a means for transmitting, via the uplink sub-band, the set of multiple uplink transmissions in accordance with the scheduling information and the RB offset.

By including or configuring the communications manager 1120 in accordance with examples as described herein, the device 1105 may support techniques for improved communication reliability, more efficient utilization of communication resources, and improved coordination between devices, among other examples.

In some examples, the communications manager 1120 may be configured to perform various operations (such as receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of configuration and determination of RB offsets for uplink transmission across SBFD and non-SBFD symbols as described herein, or the at least one processor 1140 and the at least one memory 1130 may be otherwise configured to, individually or collectively, perform or support such operations.

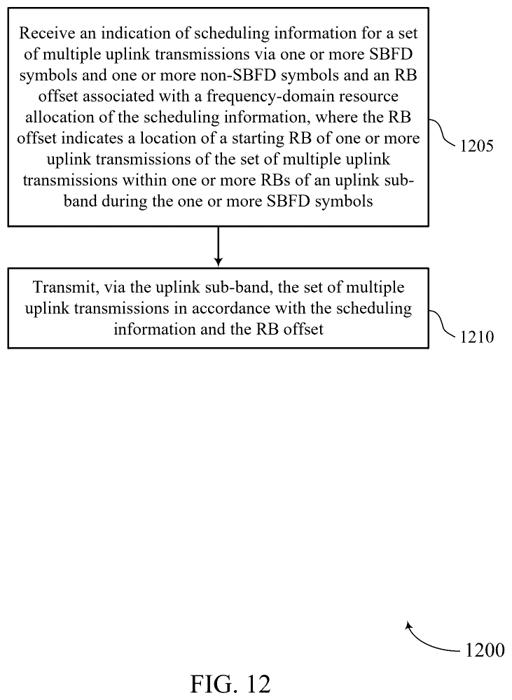

FIG. 12 shows a flowchart illustrating a method 1200 that supports configuration and determination of RB offsets for uplink transmission across SBFD and non-SBFD symbols in accordance with one or more aspects of the present disclosure. The operations of the method 1200 may be implemented by a UE or its components as described herein. For example, the operations of the method 1200 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1205, the method may include receiving an indication of scheduling information for a set of multiple uplink transmissions via one or more SBFD symbols and one or more non-SBFD symbols and an RB offset associated with an FDRA of the scheduling information, where the RB offset indicates a location of a starting RB of one or more uplink transmissions of the set of multiple uplink transmissions within one or more RBs of an uplink sub-band during the one or more SBFD symbols. The operations of 1205 may be performed in accordance with examples as disclosed herein. In some examples, aspects of the operations of 1205 may be performed by an RB offset component 1025 as described with reference to FIG. 10.

At 1210, the method may include transmitting, via the uplink sub-band, the set of multiple uplink transmissions in accordance with the scheduling information and the RB offset. The operations of 1210 may be performed in accordance with examples as disclosed herein. In some examples, aspects of the operations of 1210 may be performed by an uplink transmission component 1030 as described with reference to FIG. 10.

The following provides an overview of aspects of the present disclosure:

Aspect 1: A method for wireless communications at a UE, comprising: receiving an indication of scheduling information for a plurality of uplink transmissions via one or more SBFD symbols and one or more non-SBFD symbols and an RB offset associated with an FDRA of the scheduling information, wherein the RB offset indicates a location of a starting RB of one or more uplink transmissions of the plurality of uplink transmissions within one or more RBs of an uplink sub-band during the one or more SBFD symbols; and transmitting, via the uplink sub-band, the plurality of uplink transmissions in accordance with the scheduling information and the RB offset.

Aspect 2: The method of aspect 1, wherein receiving the indication of the scheduling information further comprises: receiving semi-static signaling indicating the RB offset.

Aspect 3: The method of any of aspects 1 through 2, wherein receiving the indication of the scheduling information further comprises: receiving semi-static signaling indicating a plurality of configured RB offsets; and selecting an RB offset of the plurality of configured RB offsets for the one or more uplink transmissions of the plurality of uplink transmissions.

Aspect 4: The method of aspect 3, wherein selecting the RB offset of the plurality of configured RB offsets comprises: receiving DCI indicating the RB offset of the plurality of configured RB offsets.

Aspect 5: The method of any of aspects 1 through 4, further comprising: selecting the location of the starting RB in accordance with a combination of the RB offset and a first RB of the uplink sub-band during the one or more SBFD symbols.

Aspect 6: The method of any of aspects 1 through 4, further comprising: selecting the location of the starting RB in accordance with applying the RB offset to a first PRB defined for the uplink sub-band during the one or more SBFD symbols or to a first PRB for an uplink BWP.

Aspect 7: The method of any of aspects 1 through 4, further comprising: selecting the location of the starting RB in accordance with a first RB of the uplink sub-band during the one or more SBFD symbols and a size of the uplink sub-band to an uplink BWP.

Aspect 8: The method of any of aspects 1 through 4, further comprising: performing a modular operation in accordance with the RB offset, a first RB of the uplink sub-band, and a size of the uplink sub-band during the one or more SBFD symbols, wherein the RB offset is a positive value spanning a range of RBs of the uplink sub-band; and selecting the location of the starting RB in accordance with the modular operation.

Aspect 9: The method of any of aspects 1 through 8, wherein receiving the indication of the scheduling information further comprises: setting the RB offset to zero in accordance with a detected absence of an explicit RB offset in the scheduling information.

Aspect 10: The method of any of aspects 1 through 4 and 9, further comprising: selecting the location of the starting RB in accordance with a first RB or a last PRB in the uplink sub-band during the one or more SBFD symbols.

Aspect 11: The method of any of aspects 1 through 4 and 9, further comprising: receiving an indication associated with selecting the starting RB with respect to the uplink sub-band during the one or more SBFD symbols or selecting the starting RB in accordance with a second starting RB during the one or more non-SBFD symbols; and selecting the starting RB with respect to the uplink sub-band during the one or more SBFD symbols in accordance with receiving the indication.

Aspect 12: The method of any of aspects 1 through 11, further comprising: selecting the starting RB to align the starting RB with a RBG grid associated with the one or more SBFD symbols.

Aspect 13: The method of any of aspects 1 through 4, 9, and 12, further comprising: performing a modular operation to determine the starting RB in accordance with a contiguity of one or more PRBs of the FDRA.

Aspect 14: The method of any of aspects 1 through 13, wherein a plurality of PRBs associated with the FDRA are within the uplink sub-band during the one or more SBFD symbols.

Aspect 15: The method of any of aspects 1 through 14, the FDRA comprises one or more gap RBs associated with a second plurality of uplink transmissions, and wherein a ratio of the one or more gap RBs to a total quantity of RBs of the FDRA is constant.

Aspect 16: The method of any of aspects 1 through 15, further comprising: transmitting an indication of a capability of the UE to support determining the starting RB according to the RB offset, wherein receiving the indication of the RB offset is in accordance with the capability of the UE.

Aspect 17: A UE for wireless communications, comprising one or more memories storing processor-executable code, and one or more processors coupled with the one or more memories and individually or collectively operable to execute the code to cause the UE to perform a method of any of aspects 1 through 16.

Aspect 18: A UE for wireless communications, comprising at least one means for performing a method of any of aspects 1 through 16.

Aspect 19: A non-transitory computer-readable medium storing code for wireless communications, the code comprising instructions executable by one or more processors to perform a method of any of aspects 1 through 16.

Aspect 20: A method for wireless communication at a UE, comprising: receiving an indication of scheduling information for a plurality of uplink transmissions via one or more SBFD symbols and one or more non-SBFD symbols and an RB offset associated with a FDRA of the scheduling information, wherein the RB offset indicates a location of a starting RB of one or more uplink transmissions of the plurality of uplink transmissions within one or more RBs of an uplink sub-band during the one or more SBFD symbols; and transmitting, via the uplink sub-band, the plurality of uplink transmissions in accordance with the scheduling information and the RB offset.

Aspect 21: The method of aspect 20, wherein receiving the indication of the scheduling information comprises: receiving, in accordance with the plurality of uplink transmissions being associated with type 1 PUSCH transmissions with a configured grant, an RRC message that comprises a configured grant configuration, wherein the configured grant configuration comprises a configured uplink grant information element, and wherein the configured uplink grant information element comprises an RRC parameter that indicates the RB offset.

Aspect 22: The method of any of aspects 20 through 21, wherein receiving the indication of the scheduling information comprises: receiving, in accordance with the plurality of uplink transmissions being associated with type 2 PUSCH transmissions with a configured grant, or in accordance with the plurality of uplink transmissions being scheduled by one or more dynamic grant PDSCH transmissions, an RRC message that comprises a PUSCH configuration, wherein the PUSCH configuration comprises a plurality of RB offsets including the RB offset.

Aspect 23: The method of aspect 22, further comprising: receiving DCI indicating the RB offset of the plurality of RB offsets.

Aspect 24: The method of any of aspects 20 through 23, wherein the location of the starting RB of the one or more uplink transmissions is at least in accordance with a first value modulo a quantity of PRBs of the uplink sub-band, and the first value comprises the RB offset added to a starting RB of an uplink BWP.

Aspect 25: The method of aspect 24, wherein the location of the starting RB of the one or more uplink transmissions is with reference to a first RB of the uplink sub-band.

Aspect 26: The method of any of aspects 20 through 25, wherein the location of the starting RB of the one or more uplink transmissions is in accordance with at least one of a starting RB of the uplink sub-band, the RB offset, the starting RB of an uplink BWP, and a quantity of PRBs of the uplink sub-band.

Aspect 27: The method of any of aspects 20 through 26, wherein the location of the starting RB of the one or more uplink transmissions is at least in accordance with a first value modulo a quantity of PRBs of the uplink sub-band, the first value comprising the RB offset added to a starting RB of an uplink BWP, and the location of the starting RB of the one or more uplink transmissions is with reference to a first RB of the uplink sub-band that is a starting PRB of a RBG grid.

Aspect 28: The method of any of aspects 20 through 27, wherein receiving the indication of the scheduling information comprises: setting the RB offset to zero in accordance with a detected absence of an explicit RB offset in the scheduling information.

Aspect 29: The method of any of aspects 20 through 28, further comprising: selecting the location of the starting RB in accordance with a combination of the RB offset and a first RB of the uplink sub-band during the one or more SBFD symbols.

Aspect 30: The method of any of aspects 20 through 28, further comprising: selecting the location of the starting RB in accordance with applying the RB offset to a first PRB defined for the uplink sub-band during the one or more SBFD symbols or to a first PRB for an uplink BWP.

Aspect 31: The method of any of aspects 20 through 28, further comprising: selecting the location of the starting RB in accordance with a first RB of the uplink sub-band during the one or more SBFD symbols and a size of the uplink sub-band to an uplink BWP.

Aspect 32: The method of any of aspects 20 through 28, further comprising: selecting the location of the starting RB in accordance with a first RB or a last PRB in the uplink sub-band during the one or more SBFD symbols.

Aspect 33: The method of any of aspects 20 through 32, further comprising: receiving an indication associated with selecting the starting RB with respect to the uplink sub-band during the one or more SBFD symbols or selecting the starting RB in accordance with a second starting RB during the one or more non-SBFD symbols; and selecting the starting RB with respect to the uplink sub-band during the one or more SBFD symbols in accordance with receiving the indication.

Aspect 34: The method of any of aspects 20 through 33, further comprising: performing a modular operation to determine the starting RB in accordance with a contiguity of one or more PRBs of the FDRA.

Aspect 35: The method of any of aspects 20 through 34, wherein a plurality of PRBs associated with the FDRA are within the uplink sub-band during the one or more SBFD symbols.

Aspect 36: The method of any of aspects 20 through 35, wherein the FDRA comprises one or more gap RBs associated with a second plurality of uplink transmissions, and a ratio of the one or more gap RBs to a total quantity of RBs of the frequency-domain resource allocation is constant.

Aspect 37: The method of any of aspects 20 through 36, further comprising: transmitting an indication of a capability of the UE to support determining the starting RB according to the RB offset, wherein receiving the indication of the RB offset is in accordance with the capability of the UE.

Aspect 38: A UE for wireless communication, comprising a processing system that includes processor circuitry and memory circuitry that stores code, the processing system configured to cause the UE to perform a method of any of aspects 20 through 37.

Aspect 39: A UE for wireless communication, comprising at least one means for performing a method of any of aspects 20 through 37.

Aspect 40: A non-transitory computer-readable medium storing code for wireless communication, the code comprising instructions executable by one or more processors to perform a method of any of aspects 20 through 37.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (such as a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (such as a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (such as receiving information), accessing (such as accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processing system that includes processor circuitry and memory circuitry that stores code, the processing system configured to cause the apparatus to:
receive an indication of scheduling information for a plurality of uplink transmissions via one or more sub-band full duplex (SBFD) symbols and one or more non-SBFD symbols and a resource block (RB) offset associated with a frequency-domain resource allocation of the scheduling information, wherein the RB offset indicates a location of a starting RB of one or more uplink transmissions of the plurality of uplink transmissions within one or more RBs of an uplink sub-band during the one or more SBFD symbols; and
transmit, via the uplink sub-band, the plurality of uplink transmissions in accordance with the scheduling information and the RB offset.

2. The apparatus of claim 1, wherein, to receive the indication of the scheduling information, the processing system is further configured to cause the apparatus to:
receive, in accordance with the plurality of uplink transmissions being associated with type 1 physical uplink shared channel transmissions with a configured grant, a radio resource control message that comprises a configured grant configuration, wherein the configured grant configuration comprises a configured uplink grant information element, and wherein the configured uplink grant information element comprises a radio resource control parameter that indicates the RB offset.

3. The apparatus of claim 1, wherein, to receive the indication of the scheduling information, the processing system is further configured to cause the apparatus to:
receive, in accordance with the plurality of uplink transmissions being associated with type 2 physical uplink shared channel transmissions with a configured grant, or in accordance with the plurality of uplink transmissions being scheduled by one or more dynamic grant physical downlink shared channel transmissions, a radio resource control message that comprises a physical uplink shared channel configuration, wherein the physical uplink shared channel configuration comprises a plurality of RB offsets including the RB offset.

4. The apparatus of claim 3, wherein the processing system is further configured to cause the apparatus to:
receive downlink control information indicating the RB offset of the plurality of RB offsets.

5. The apparatus of claim 1, wherein the location of the starting RB of the one or more uplink transmissions is at least in accordance with a first value modulo a quantity of physical RBs (PRBs) of the uplink sub-band, and wherein the first value comprises the RB offset added to a starting RB of an uplink bandwidth part.

6. The apparatus of claim 5, wherein the location of the starting RB of the one or more uplink transmissions is with reference to a first usable RB of the uplink sub-band.

7. The apparatus of claim 1, wherein the location of the starting RB of the one or more uplink transmissions is in accordance with at least one of a starting usable RB of the uplink sub-band, the RB offset, the starting RB of an uplink bandwidth part, and a quantity of physical usable RBs (PRBs) of the uplink sub-band.

8. The apparatus of claim 1, wherein the location of the starting RB of the one or more uplink transmissions is at least in accordance with a first value modulo a quantity of physical RBs (PRBs) of the uplink sub-band, the first value comprising the RB offset added to a starting RB of an uplink bandwidth part, and wherein the location of the starting RB of the one or more uplink transmissions is with reference to a first RB of the uplink sub-band that is a starting physical resource block of a resource block group grid.

9. The apparatus of claim 1, wherein, to receive the indication of the scheduling information, the processing system is further configured to cause the apparatus to:
set the RB offset to zero in accordance with a detected absence of an explicit RB offset in the scheduling information.

10. The apparatus of claim 1, wherein the processing system is further configured to cause the apparatus to:
select the location of the starting RB in accordance with a combination of the RB offset and a first RB of the uplink sub-band during the one or more SBFD symbols.

11. The apparatus of claim 1, wherein the processing system is further configured to cause the apparatus to:
select the location of the starting RB in accordance with applying the RB offset to a first physical resource block defined for the uplink sub-band during the one or more SBFD symbols or to a first physical resource block for an uplink bandwidth part.

12. The apparatus of claim 1, wherein the processing system is further configured to cause the apparatus to:
select the location of the starting RB in accordance with a first RB of the uplink sub-band during the one or more SBFD symbols and a size of the uplink sub-band to an uplink bandwidth part.

13. The apparatus of claim 1, wherein the processing system is further configured to cause the apparatus to:
select the location of the starting RB in accordance with a first RB or a last physical resource block in the uplink sub-band during the one or more SBFD symbols.

14. The apparatus of claim 1, wherein the processing system is further configured to cause the apparatus to:
receive an indication associated with selecting the starting RB with respect to the uplink sub-band during the one or more SBFD symbols or selecting the starting RB in accordance with a second starting RB during the one or more non-SBFD symbols; and
select the starting RB with respect to the uplink sub-band during the one or more SBFD symbols in accordance with receiving the indication.

15. The apparatus of claim 1, wherein the processing system is further configured to cause the apparatus to:
perform a modular operation to determine the starting RB in accordance with a contiguity of one or more physical resource blocks of the frequency-domain resource allocation.

16. The apparatus of claim 1, wherein a plurality of physical resource blocks associated with the frequency-domain resource allocation are within the uplink sub-band during the one or more SBFD symbols.

17. The apparatus of claim 1, wherein the frequency-domain resource allocation comprises one or more gap RBs associated with a second plurality of uplink transmissions, and wherein a ratio of the one or more gap RBs to a total quantity of RBs of the frequency-domain resource allocation is constant.

18. The apparatus of claim 1, wherein the processing system is further configured to cause the apparatus to:
transmit an indication of a capability of the UE to support determining the starting RB according to the RB offset, wherein receiving the indication of the RB offset is in accordance with the capability of the UE.

19. A method for wireless communication at a user equipment (UE), comprising:
receiving an indication of scheduling information for a plurality of uplink transmissions via one or more sub-band full duplex (SBFD) symbols and one or more non-SBFD symbols and a resource block (RB) offset associated with a frequency-domain resource allocation of the scheduling information, wherein the RB offset indicates a location of a starting RB of one or more uplink transmissions of the plurality of uplink transmissions within one or more RBs of an uplink sub-band during the one or more SBFD symbols; and
transmitting, via the uplink sub-band, the plurality of uplink transmissions in accordance with the scheduling information and the RB offset.

20. A non-transitory computer-readable medium storing code for wireless communications, the code comprising instructions executable by one or more processors to:
receive an indication of scheduling information for a plurality of uplink transmissions via one or more sub-band full duplex (SBFD) symbols and one or more non-SBFD symbols and a resource block (RB) offset associated with a frequency-domain resource allocation of the scheduling information, wherein the RB offset indicates a location of a starting RB of one or more uplink transmissions of the plurality of uplink transmissions within one or more RBs of an uplink sub-band during the one or more SBPD symbols; and
transmit, via the uplink sub-band, the plurality of uplink transmissions in accordance with the scheduling information and the RB offset.
